(19) United States
(12) Patent Application Publication
(10) Pub. No.: US 2011/0276509 A1
(43) Pub. Date: Nov. 10, 2011

(54) SYSTEM AND METHOD FOR UNIVERSITY MODEL GRAPH BASED VISUALIZATION

(75) Inventors: Sridhar Varadarajan, Bangalore (IN); Srividya Gopalan, Bangalore (IN); Preethy Iyer, Bangalore (IN)

(73) Assignee: SRM Institute of Science and Technology, Chennai (IN)

(21) Appl. No.: 12/909,988

(22) Filed: Oct. 22, 2010

(30) Foreign Application Priority Data
May 6, 2010 (IN) 1848/CHE/2010

(51) Int. Cl. G06Q 50/00

(52) U.S. Cl. 705/326

(57) ABSTRACT

An educational institution (also referred as a university) is rich with multiple kinds of data: students, faculty members, departments, divisions, and at university level. A structural representation that captures the essence of all of the relationships in a unified manner has concise information about the educational institution, and visualization is a way to bring out all this information in an explicit manner so that the various of the users of the educational institution system understand effectively their system. A system and method for visualization based on the structural representation of a university along a variety of dimensions is discussed.

1. A reference is made to the applicants' earlier Indian patent application titled “System and Method for an Influence based Structural Analysis of a University” with the application number 1269/CHE2010 filed on 6 May 2010.

2. A reference is made to another of the applicants' earlier Indian patent application titled “System and Method for Constructing a University Model Graph” that is under filing process and the application number and the filing date are yet to obtained.

### FIELD OF THE INVENTION

The present invention relates to the visualization of the information about a university in general, and more particularly, visualization of the university based on the structural representations. Still more particularly, the present invention relates to a system and method for multiple multi-dimensions based visualization of a model graph associated with the university.

### BACKGROUND OF THE INVENTION

An Educational Institution (EI) (also referred as university) comprises of a variety of entities: students, faculty members, departments, divisions, labs, libraries, special interest groups, etc. University portals provide information about the universities and act as a window to the external world. A typical portal of a university provides information related to (a) Goals, Objectives, Historical Information, and Significant Milestones, of the university; (b) Profile of the Labs, Departments, and Divisions; (c) Profile of the Faculty Members; (d) Significant Achievements; (e) Admission Procedures; (f) Information for Students; (g) Library; (h) On- and Off-Campus Facilities; (i) Research; (j) External Collaborations; (k) Information for Collaborators; (l) News and Events; (m) Alumni; and (n) Information Resources. It is a requirement to provide a visualization of the university information so that the various of the users of the educational institution system get the information of their need, interest, and choice in a very concise and comprehensive manner. In order to be able to assess the university in a manner for to be used for multiple purposes such as for prospective students, candidates exploring opportunities within the university, for the funding agencies, and for providing an objectivized view of the information for the university visitors, there is a need to provide the visualization of the information contained in a structural representation of the university that is based on the known information about the university. For example, the visualization provides prospective students to have a better understanding of the university they are exploring to enroll and funding agencies to get a better picture of the university that they are planning to fund.

### DESCRIPTION OF RELATED ART

U.S. Pat. No. 7,734,607 to Grinstein; Georges (Ashby, Mass.), Gee; Alexander (Lowell, Mass.), Cvek; Urska (Shreveport, La.), Goodell; Howard (Salem, N.H.), Li; Hongli (Westborough, Mass.), Yu; Min (North Chelmsford, Mass.), Zhou; Jianping (Acton, Mass.), Gupta; Vivek (Littleton, Mass.), Smrtic; Mary Beth (Westford, Mass.), Lawrence; Christine (Waltham, Mass.), Chiang; Chih-Hung (North Chelmsford, Mass.) for “Universal visualization platform” (issued on Jun. 8, 2010 and assigned to University of Massachusetts (Boston, Mass.)) provides methods and apparatus, including computer program products, for a universal visualization platform.

U.S. Pat. No. 7,730,085 to Hassan; Hany M.; (Cairo, EG); Mostafa; Hala; (Cairo, EG) for “Method and System for Extracting and Visualizing Graph-Structured Relations from Unstructured Text” (issued on Jun. 1, 2010 and assigned to International Business Machines Corporation (Armonk, N.Y.)) describes a system, method and computer program for automatically extracting and mining relations and related entities from unstructured text and representing the extracted information into a graph, and manipulating the resulting graph to gain more insight into the information it contains.

U.S. Pat. No. 6,515,666 to Cohen; Jonathan Drew (Hanover, Md.) for “Method for constructing graph abstractions” (issued on Feb. 4, 2003) describes a method of constructing graph abstractions using a computer and the abstraction is presented on a computer display for to be used by a human viewer to understand a more complicated set of raw graphs.

United States Patent Application 20070022000 titled “Data analysis using graphical visualization” by Bodart; Andrew J.; (New York, N.Y.); Vallier; William E.; (Bound Brook, N.J.) (filed on Jul. 22, 2005 and assigned to Accenture LLP, Palo Alto, Calif.) provides methods and systems are for creating interactive graphical representations (e.g., interactive radial graphs) of operational data in order to enhance root cause analysis and other forms of operational analysis.

“IVEA: An Information Visualization Tool for Personalized Exploratory Document Collection Analysis” by Thai; VinhTuan, Handschuh; Siegfried, and Decker; Stefan (appeared in the Proceedings of 5th European Semantic Web Conference (ESWC 2008), 1-5 Jun., 2008, Tenerife, Spain published by Springer as Lecture Notes in Computer Science volume 5021) describes IVEA (Information Visualization for Exploratory Document Collection Analysis), an innovative visualization tool which employs the PIMO (Personal Information Model) ontology to provide the knowledge workers with an interactive interface allowing them to browse for information in a personalized manner.

“Supporting the Analytical Reasoning Process in Information Visualization” by Shrinivasan; Yedendra and van Wijk; Jarke (appeared in the ACM Human Factors in Computing Systems (CHI), Florence, Italy, 5-10 Apr. 2008) describes a new information visualization framework that supports the analytical reasoning process.

“A Visual Mapping Approach for Trend Identification in Multi-Attribute Data” by Bockstedt; Jesse and Adomavicius; Gediminas (appeared in the Proceedings of the 17th Workshop on Information Technology and Systems (WITS '07), Montreal, Canada, December 2007) describes a temporal data analysis and visualization technique for representing trends in multi-attribute temporal data using a clustering-based approach.

“Visualizing Missing Data: Classification and Empirical Study” by Eaton; Cyntrica, Plaisant; Catherine, and Drizd; Terence (appeared in Proceedings of the Tenth IFIP TC13 International Conference on Human-Computer Interaction 12-16 Sep. 2005, Rome, Italy (INTERACT 2005), 861-872, Springer) describes the fact that the most visualization tools fail to provide support for missing data and provide a report on the sources of missing data and a categorization of visualization techniques based on the impact missing data have on the display.

The known systems do not address the issue of visualization based on a comprehensive modeling of an educational institution at various levels in order to be able to provide adequate views to help assess the educational institution at various levels. The present invention provides for system and method for visualization based on a comprehensive modeling of the educational institution at multiple levels based on a set of entities, a set of entity-instances, and the mutual influences among these entities and entity-instances.

### SUMMARY OF THE INVENTION

The primary objective of the invention is to provide multiple multi-dimensional views of the information of an educational institution in a concise and comprehensive manner for helping in the assessment of the educational institution at elemental and component levels.

One aspect of the present invention is to provide an abstract view, a details view, and a variations view of the educational institution along Influence dimension of an entity or an instance of an entity of the educational institution.

Another aspect of the present invention is to provide an abstract view, a details view, and a variations view of the educational institution along Assessment dimension of an entity or an instance of an entity of the educational institution.

Yet another aspect of the present invention is to provide an abstract view, a details view, and a variations view of the educational institution along Parametric dimension of an entity or an instance of an entity of the educational institution.

Another aspect of the present invention is to provide views of the educational institution along Relationship dimensions at pair of entities, multiple entities, and rel-based entities levels.

Yet another aspect of the present invention is to provide views of the educational institution along Partitioning dimensions based on syntactic partitioning, semantic partitioning, and denseness based partitioning.

Another aspect of the present invention is to provide views of the educational institution along Threshold dimensions based on goodness, averageness, and badness characterizations.

Yet another aspect of the present invention is to provide views of the educational institution along Tracker dimensions based on ascending, descending, and sustaining behaviors.

Another aspect of the present invention is to provide views of the educational institution along Performance dimensions bringing out Star, Gold, and Bronze performers.

Yet another aspect of the present invention is to provide views of the educational institution along Impact dimensions bringing out Sun-kind, moon-kind, and blackhole-kind impacts.

Another aspect of the present invention is to provide views of the educational institution along Chain dimensions brining out strong, weak, and strong-weak chains.

In a preferred embodiment, the present invention provides a system for a university model graph based visualization of the information about a university with the help of a plurality of assessments and a plurality of influence values contained in a university model graph database to help in providing an effective understanding of said university at multiple levels,

said university having a plurality of entities and a plurality of entity-instances, wherein each of said plurality of entity-instances is an instance of an entity of said plurality of entities, and
said university model graph having a plurality of models, a plurality of abstract nodes, a plurality of nodes, a plurality of abstract edges, a plurality of semi-abstract edges, and a plurality of edges, with each abstract node of said plurality of abstract nodes corresponding to an entity of said plurality of entities,
each node of said plurality of nodes corresponding to an entity-instance of said plurality of entity-instances, and
each abstract node of said plurality of abstract nodes is associated with a model of said plurality of models, and
a node of said plurality of nodes is connected to an abstract node of said plurality of abstract nodes through an abstract edge of said plurality of abstract edges, wherein said node represents an instance of an entity associated with said abstract node and said node is associated with an instantiated model and a base score, wherein said instantiated model is based on a model associated with said abstract node, and said base score is computed based on said instantiated model and is a value between 0 and 1,
a source abstract node of said plurality of abstract nodes is connected to a destination abstract node of said plurality of abstract nodes by a directed abstract edge of said plurality of abstract edges and said directed abstract edge is associated with an entity influence value of said plurality of influence values, wherein said entity influence value is a value between −1 and +1;
a source node of said plurality of nodes is connected to a destination node of said plurality of nodes by a directed edge of said plurality of edges and said directed edge is associated with an influence value of said plurality influence values, wherein said influence value is a value between −1 and +1;
a source node of said plurality of nodes is connected to a destination abstract node of said plurality of abstract nodes by a directed semi-abstract edge of said plurality of semi-abstract edges and said directed semi-abstract edge is associated with an entity-instance-entity-influence value of said plurality influence values, wherein said influence value is a value between −1 and +1; and
a source abstract node of said plurality of abstract nodes is connected to a destination node of said plurality of nodes by a directed semi-abstract edge of said plurality of semi-abstract edges and said directed semi-abstract edge is associated with an entity-entity-instance-influence value of said plurality influence values, wherein said influence value is a value between −1 and +1, said system comprising,
means for providing of visualization of said university model graph of said university based on a three major dimensions consisting of an assessment dimension, an influence dimension, and a parametric dimension;
means for providing of visualization of said university model graph of said university based on a three minor dimensions consisting of an abstract view dimension, a details view dimension, and a variations view dimension;
means for providing of visualization of said university model graph of said university based on a three relationship dimensions consisting of a pair level dimension, a multiple level dimension, and a rel-based dimension;
means for providing of visualization of said university model graph of said university based on a three partition dimensions consisting of a syntactic partition dimension, a semantic partition dimension, and a denseness based partitioning;
means for providing of visualization of said university model graph of said university based on a three threshold dimensions consisting of a goodness dimension, an averageness dimension, and a badness dimension;
means for providing of visualization of said university model graph of said university based on a three tracker dimensions consisting of an ascending behavior dimension, a descending behavior dimension, and a sustaining behavior dimension;
means for providing of visualization of said university model graph of said university based on a three performance dimensions consisting of a star performer dimension, a gold performer dimension, and a bronze performer dimension;
means for providing of visualization of said university model graph of said university based on a three impact dimensions consisting of a sun-kind impact dimension, a moon-kind impact dimension, and a blackhole-kind impact dimension; and
means for providing of visualization of said university model graph of said university based on a three chain dimensions consisting of a strong chain dimension, a weak chain dimension, and a strong-weak chain dimension.
   (BASED ON FIGS. 1, 1a, 1b, 2, and 3)

### BRIEF DESCRIPTION OF THE DRAWINGS

FIG. 1 provides an overview of an EI Visualization System.

FIG. 1a provides an illustrative University Model Graph.

FIG. 1b provides the elements of University Model Graph.

FIG. 2 depicts an illustrative EI Visualization Aspects.

FIG. 3 depicts an illustrative EI Visualization Dimensions.

FIG. 4 provides the visualization based on 3 Major Dimensions.

FIG. 5 describes an approach for 1-D Assessment Visualization.

FIG. 6 describes an approach for 1-D Influence Visualization.

FIG. 7 describes an approach for 1-D Parametric Visualization.

FIG. 8 describes an approach for 2-D Visualization based on Assessment and Influence Values.

FIG. 9 describes an approach for 2-D Visualization based on Assessment and Critical Parameter Values.

FIG. 10 describes an approach for Visualization based on Pair Relationship Dimension.

FIG. 10a provides an illustrative Visualization based on Pair Relationship Dimension.

FIG. 10b describes an approach for Visualization based on Multiple Relationship Dimension.

FIG. 10c describes an approach for Visualization based on Rel-based Relationship Dimension.

FIG. 11 describes an approach for Visualization based on Syntactic Partitioning.

FIG. 11a describes an approach for Visualization based on Semantic Partitioning.

FIG. 11b describes an approach for Visualization based on Denseness Partitioning.

FIG. 12 describes an approach for Visualization based on Threshold Dimensions.

FIG. 13 describes an approach for Visualization based on Tracker Dimensions.

FIG. 14 describes an approach for Visualization based on Performance Dimensions.

FIG. 15 describes an approach for Visualization based on Impact Dimensions.

FIG. 16 describes an approach for Visualization based on Chain Dimensions.

### DETAILED DESCRIPTION OF THE PREFERRED EMBODIMENTS

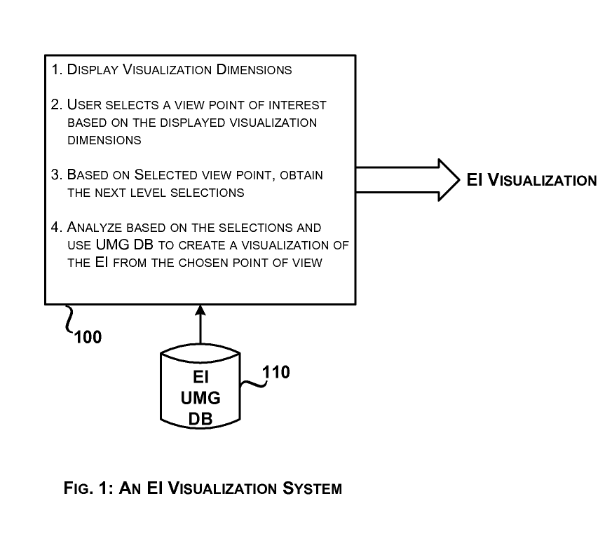

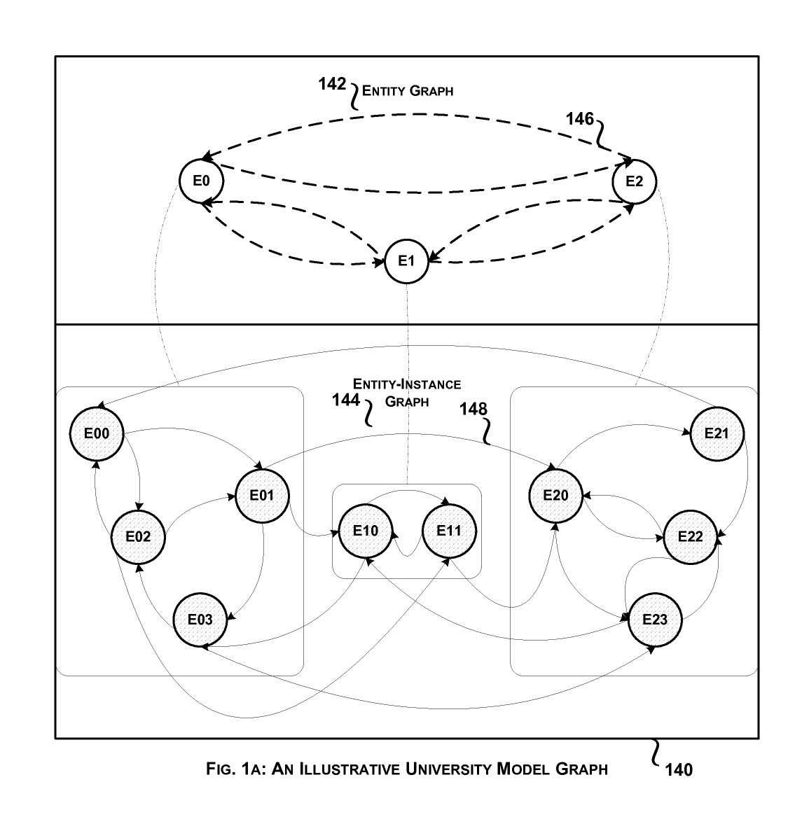

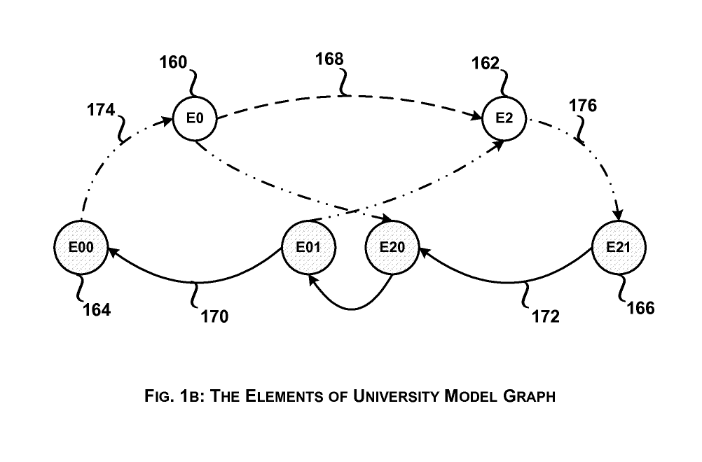

FIG. 1 depicts an overview of EI Visualization System. The main steps (100) are to select a view point of interest to a user so that University Model Graph (UMG) Database (DB) (110) of a university is analyzed from the selected view point to create the view point visualization. Note that, in the sequel, “university” and “educational institution” are used interchangeably. UMG database comprises of a university model graph associated with the university that is a structural representation of the information about the educational institution.

FIG. 1a depicts an illustrative University Model Graph. 140 describes UMG as consisting of two main components: Entity Graph (142) and Entity-Instance Graph (144). Entity graph consists of entities of the university as its nodes and an abstract edge (146) or abstract link is a directed edge that connects two entities of the entity graph. Note that edge and link are used interchangeably. The weight associated with this abstract edge is the influence factor or influence value indicating nature and quantum of influence of the source entity on the destination entity. Again, influence factor and influence value are used interchangeably. Similarly, the nodes in the entity-instance graph are the entity instances and the edge (148) or the link between two entity-instances is a directed edge and the weight associated with the edge indicates the nature and quantum of influence of the source entity-instance on the destination entity-instance.

FIG. 1b provides the elements of a University Model Graph. The fundamental elements are nodes and edges. There are two kinds of nodes: Abstract nodes (160 and 162) and Nodes (164 and 166); There are three kinds of directed edges or links: Abstract links (168), links (170 and 172), and semi-abstract links (174 and 176). As part of the modeling, the abstract nodes are mapped onto entities and nodes are mapped onto the instances of the entities; the weight associated with an abstract link corresponds to an entity influence value (EI-Value), the weight associated with a semi-abstract link corresponds to either an entity-entity-instance influence value (EIEI-Value) or an entity-instance-entity influence value (IEEI-Value), and finally, the weight associated with a link corresponds to an entity-instance influence value (I-Value). Note that edges and links are used interchangeably. Further, each entity is associated with a model and an instance of an entity is associated with a base score and an instantiated model, wherein the base score is computed based on the associated instantiated model and denotes the assessment of the entity instance.

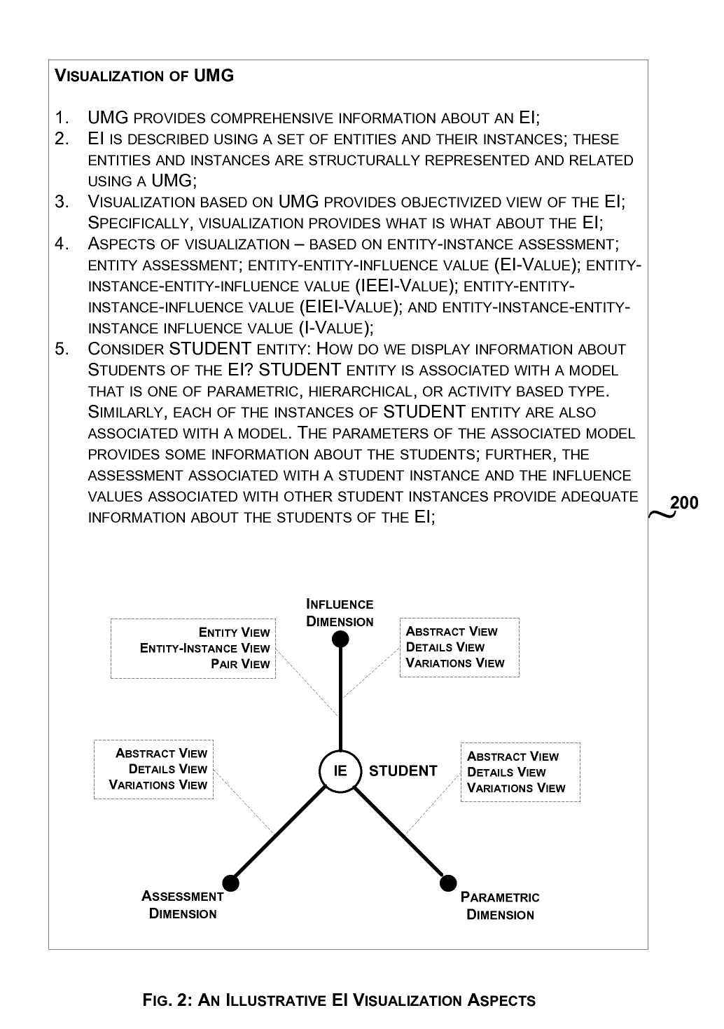

FIG. 2 provides an Illustrative EI Visualization Aspects.

### Visualization of UMG (200):

1. UMG provides comprehensive information about an EI;
2. EI is described using a set of entities and their instances; these entities and instances are structurally represented and related using a UMG;
3. Visualization based on UMG provides objectivized view of the EI; Specifically, visualization provides what is what about the EI;
4. Aspects of visualization—based on entity-instance assessment; entity assessment; entity-entity-influence value (EI-Value); entity-instance-entity-influence value (IEEI-Value); entity-entity-instance-influence value (EIEI-Value); and entity-instance-entity-instance influence value (I-Value);
5. Consider STUDENT entity: How do we display information about Students of the EI? STUDENT entity is associated with a model that is one of parametric, hierarchical, or activity based type. Similarly, each of the instances of STUDENT entity are also associated with a model. The parameters of the associated model provides some information about the students; further, the assessment associated with a student instance and the influence values associated with other student instances provide adequate information about the students of the EI;

Note that there are three dimensions of interest: Influence dimension, Assessment dimension, and Parametric dimension. For each of these three dimensions, the information gets visualized at abstract level (conciseness), details level (comprehensiveness), and variations (time based) level. Further, the above multi-dimensional view is provide for an entity, an entity-instance, a pair of entities, or a pair of entity instances.

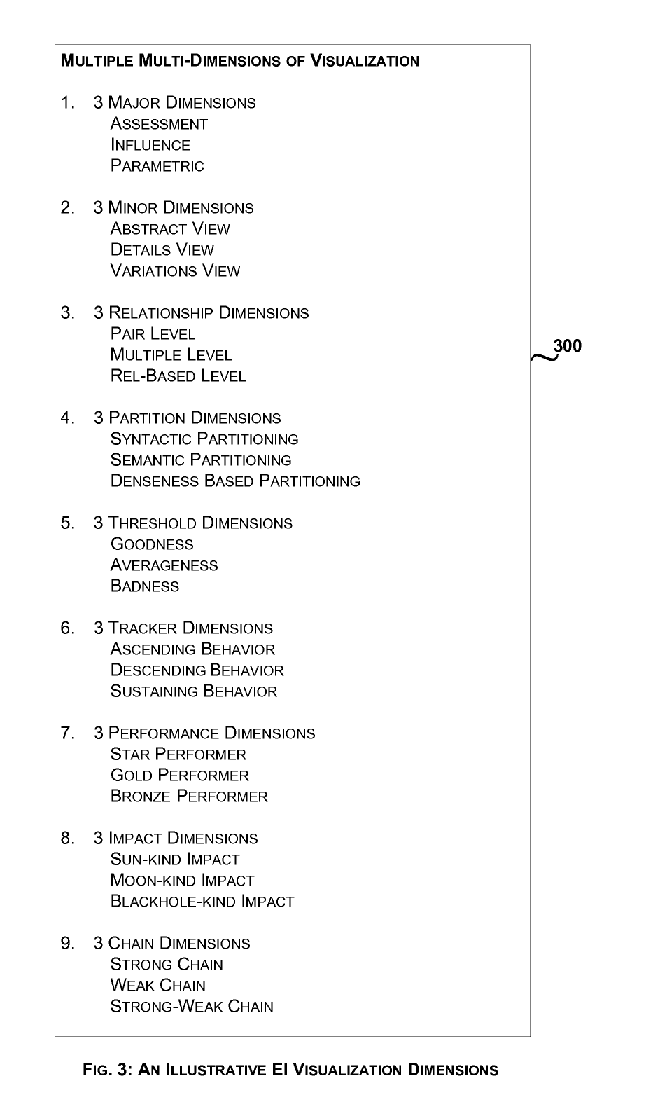

FIG. 3 depicts an Illustrative EI Visualization Dimensions.

Multiple Multi-Dimensions of Visualization (300): The visualization exploits all of the information available in UMG and brings it out in multiple ways for information dissemination. These multiple ways are being called as multiple dimensions and the corresponding means are as follows:
1. Means for providing of visualization of a university model graph of a university based on 3 Major Dimensions are:
   Assessment dimension
   Influence dimension
   Parametric dimension

Each entity or entity-instance has an assessment associated with it and is based on a model that is parametric. Similarly each entity or entity-instance influences another entity or entity-instance; Visualization brings out all of these in an effective manner for the users of the EI Visualization System to get a better understanding of the education institution.
2. Means for providing of visualization of the university model graph of the university based on 3 Minor Dimensions are:
   Abstract View dimension
   Details View dimension
   Variations View dimension

Each of the three major dimensions is elaborated using the above mentioned three minor dimensions. That is, for example, an entity-instance assessment gets described in an abstract view that provides an assessment summary information while in a details view, the assessment information gets provides over a period of time.
3. Means for providing of visualization of the university model graph of the university based on 3 Relationship Dimensions are:
   Pair Level dimension
   Multiple Level dimension
   Rel-Based dimension

A kind of visualization involves analyzing and displaying information about a set of entities or entity-instances. And, this set consists of a pair of entities or entity-instances, an explicitly defined set of entities or entity-instances, or implicitly defined using a relationship.
4. Means for providing of visualization of the university model graph of the university based on 3 Partition Dimensions are:
   Syntactic Partitioning dimension
   Semantic Partitioning dimension
   Denseness Based Partitioning dimension

Another useful visualization involves partitioning of a UMG based on, say, syntactic conditions, semantic conditions, or certain special conditions, and depicting the characteristic of the educational institution based on characterization of the elements of the partition.
5. Means for providing of visualization of the university model graph of the university based on 3 Threshold Dimensions are:
   Goodness dimension
   Averageness dimension
   Badness dimension

This utilizes pre-defined thresholds to provide a useful visualization of the UMG.
6. Means for providing of visualization of the university model graph of the university based on 3 Tracker Dimensions are:
   Ascending Behavior dimension
   Descending Behavior dimension
   Sustaining Behavior dimension

These dimensions are combined with threshold dimensions to depict UMG based information over a period of time.
7. Means for providing of visualization of the university model graph of the university based on 3 Performance Dimensions are:
   Star Performer dimension
   Gold Performer dimension
   Bronze Performer dimension

These dimensions provide a performance based visualization of UMG.
8. Means for providing of visualization of the university model graph of the university based on 3 Impact Dimensions are:
   Sun-kind Impact dimension
   Moon-kind Impact dimension
   Blackhole-kind Impact dimension

These dimensions help visualize the impact of the entities and entity-instances.
9. Means for providing of visualization of the university model graph of the university based on 3 Chain Dimensions are:
   Strong Chain dimension
   Weak Chain dimension
   Strong-Weak Chain dimension

This visualization is based on the identification of a set of chains based on UMG and characterization of the same to provide yet another view point of the educational institution.

It is stated here that the visualization along the above multiple multi-dimensions is applicable with respect to the following: Entities that a part of UMG, Entity-Instances that a part of UMG, and any combination of Entities and Entity-Instances.

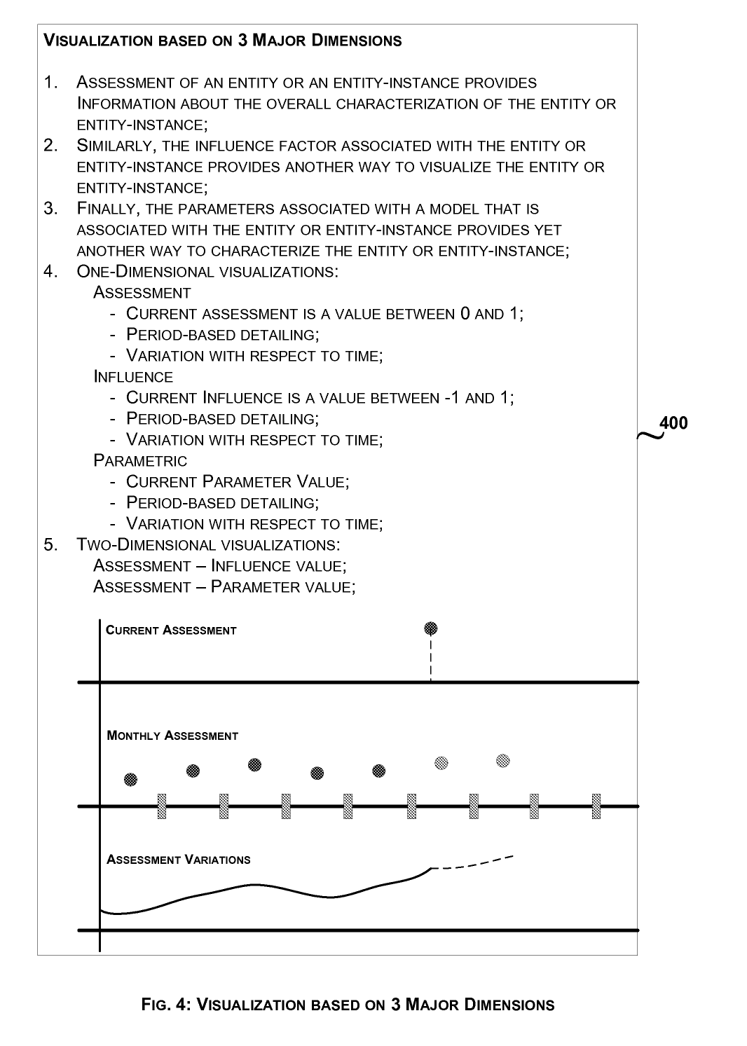

FIG. 4 depicts the Visualization based on 3 Major Dimensions.

Means and characteristics of Visualization based on 3 Major Dimensions (400):
1. Assessment of an entity or an entity-instance provides Information about the overall characterization of the entity or entity-instance;
2. Similarly, the influence factor associated with the entity or entity-instance provides another way to visualize the entity or entity-instance;
3. Finally, the parameters associated with a model that is associated with the entity or entity-instance provides yet another way to characterize the entity or entity-instance;
4. One-Dimensional visualizations:
   Assessment
      Current assessment is a value between 0 and 1;
      Period-based detailing;
      Variation with respect to time;
   Influence
      Current Influence is a value between −1 and 1;
      Period-based detailing;
      Variation with respect to time;
   Parametric
      Current Parameter Value;
      Period-based detailing;
      Variation with respect to time;
5. Two-Dimensional visualizations:
   Assessment—Influence value;
   Assessment—Parameter value;

As depicted, Current Assessment is a single value between 0 and 1, while Monthly Assessment provides detailing of the assessment over a period with the computed abstracted monthly values. Finally, the variations provide how assessment varies over a period of time. Note that both monthly assessments and assessment variations provide an opportunity to look into future through predictions.

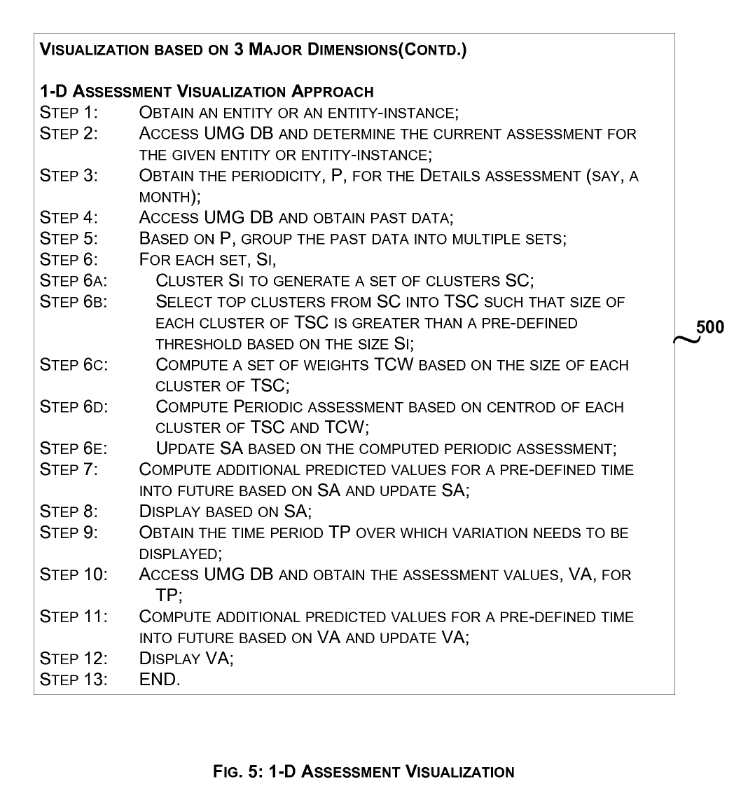

FIG. 5 describes an approach for 1-D Assessment Visualization.

Visualization based on 3 Major Dimensions (Contd.)

Means and approach for 1-D Assessment Visualization (500):
Step 1: Obtain an entity or an entity-instance;
Step 2: Access UMG DB and determine the current assessment for the given entity or entity-instance;
Step 3: Obtain the periodicity, P, for the Details assessment (say, a month);
Step 4: Access UMG DB and obtain past data;
Step 5: Based on P, group the past data into multiple sets;
Step 6: For each set, Si,
Step 6a: Cluster Si to generate a set of clusters SC;
Step 6b: Select top clusters from SC into TSC such that size of each cluster of TSC is greater than a pre-defined threshold based on the size Si;
Step 6c: Compute a set of weights TCW based on the size of each cluster of TSC;
Step 6d: Compute Periodic assessment based on centrod of each cluster of TSC and TCW;
Step 6e: Update SA based on the computed periodic assessment;
Step 7: Compute additional predicted values for a pre-defined time into future based on SA and update SA;
Step 8: Display based on SA;
Step 9: Obtain the time period TP over which variation needs to be displayed;
Step 10: Access UMG DB and obtain the assessment values, VA, for TP;
Step 11: Compute additional predicted values for a pre-defined time into future based on VA and update VA;
Step 12: Display VA;
Step 13: END.

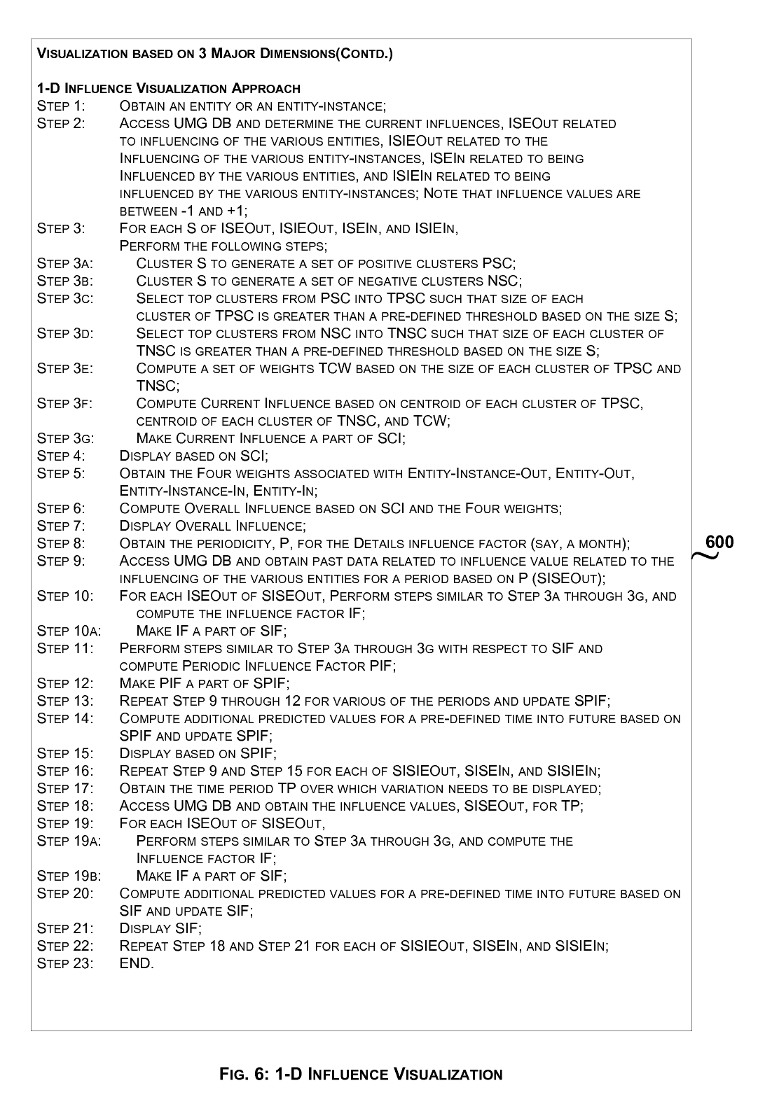

FIG. 6 describes an approach for 1-D Influence Visualization.

Visualization based on 3 Major Dimensions (Contd.)

Means and approach for 1-D Influence Visualization (600):
Step 1: Obtain an entity or an entity-instance;
Step 2: Access UMG DB and determine the current influences, ISEOut related to influencing of
the various entities, ISIEOut related to the influencing of the various entity-instances, ISEIn related to being influenced by the various entities, and ISIEIn related to being influenced by the various entity-instances; Note that influence values are between −1 and +1;
Step 3: For each S of ISEOut, ISIEOut, ISEIn, and ISIEIn, Perform the following steps;
Step 3a: Cluster S to generate a set of positive clusters PSC;
Step 3b: Cluster S to generate a set of negative clusters NSC;
Step 3c: Select top clusters from PSC into TPSC such that size of each cluster of TPSC is greater than a pre-defined threshold based on the size 5;
Step 3d: Select top clusters from NSC into TNSC such that size of each cluster of TNSC is greater than a pre-defined threshold based on the size 5;
Step 3e: Compute a set of weights TCW based on the size of each cluster of TPSC and TNSC;
Step 3f: Compute Current Influence based on centroid of each cluster of TPSC, centroid of each cluster of TNSC, and TCW;
Step 3g: Make Current Influence a part of SCI;
Step 4: Display based on SCI;
Step 5: Obtain the Four weights associated with Entity-Instance-Out, Entity-Out, Entity-Instance-In, Entity-In;
Step 6: Compute Overall Influence based on SCI and the Four weights;
Step 7: Display Overall Influence;
Step 8: Obtain the periodicity, P, for the Details influence factor (say, a month);
Step 9: Access UMG DB and obtain past data related to influence value related to the influencing of the various entities for a period based on P (SISEOut);
Step 10: For each ISEOut of SISEOut, Perform steps similar to Step 3a through 3g , and compute the influence factor IF;
Step 10a: Make IF a part of SIF;
Step 11: Perform steps similar to Step 3a through 3g with respect to SIF and compute Periodic Influence Factor PIF;
Step 12: Make PIF a part of SPIF;
Step 13: Repeat Step 9 through 12 for various of the periods and update SPIF;
Step 14: Compute additional predicted values for a pre-defined time into future based on SPIF and update SPIF;
Step 15: Display based on SPIF;
Step 16: Repeat Step 9 and Step 15 for each of SISIEOut, SISEIn, and SISIEIn;
Step 17: Obtain the time period TP over which variation needs to be displayed;
Step 18: Access UMG DB and obtain the influence values, SISEOut, for TP;
Step 19: For each ISEOut of SISEOut,
Step 19a: Perform steps similar to Step 3a through 3g, and compute the Influence factor IF;
Step 19b: Make IF a part of SIF;
Step 20: Compute additional predicted values for a pre-defined time into future based on SIF and update SIF;
Step 21: Display SIF;
Step 22: Repeat Step 18 and Step 21 for each of SISIEOut, SISEIn, and SISIEIn;
Step 23: END.

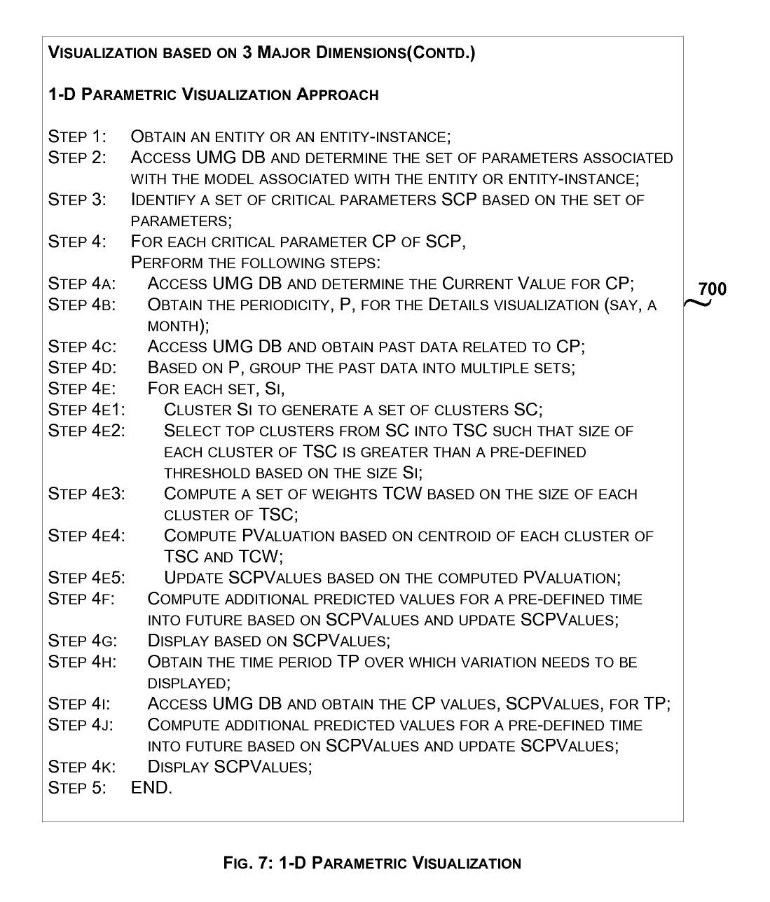

FIG. 7 describes an approach for 1-D Parametric Visualization.

Visualization based on 3 Major Dimensions (Contd.)

Means and approach for 1-D Parametric Visualization (700):
Step 1: Obtain an entity or an entity-instance;
Step 2: Access UMG DB and determine the set of parameters associated with the model associated with the entity or entity-instance;
Step 3: Identify a set of critical parameters SCP based on the set of parameters;
Step 4: For each critical parameter CP of SCP, Perform the following steps:
Step 4a: Access UMG DB and determine the Current Value for CP;
Step 4b: Obtain the periodicity, P, for the Details visualization (say, a month);
Step 4c: Access UMG DB and obtain past data related to CP;
Step 4d: Based on P, group the past data into multiple sets;
Step 4e: For each set, Si,
Step 4e1: Cluster Si to generate a set of clusters SC;
Step 4e2: Select top clusters from SC into TSC such that size of each cluster of TSC is greater than a pre-defined threshold based on the size Si;
Step 4e3: Compute a set of weights TCW based on the size of each cluster of TSC;
Step 4e4: Compute PValuation based on centroid of each cluster of TSC and TCW;
Step 4e5: Update SCPValues based on the computed PValuation;
Step 4f: Compute additional predicted values for a pre-defined time into future based on SCPValues and update SCPValues;
Step 4g: Display based on SCPValues;
Step 4h: Obtain the time period TP over which variation needs to be displayed;
Step 4i: Access UMG DB and obtain the CP values, SCPValues, for TP;
Step 4j: Compute additional predicted values for a pre-defined time into future based on SCPValues and update SCPValues;
Step 4k: Display SCPValues;
Step 5: END.

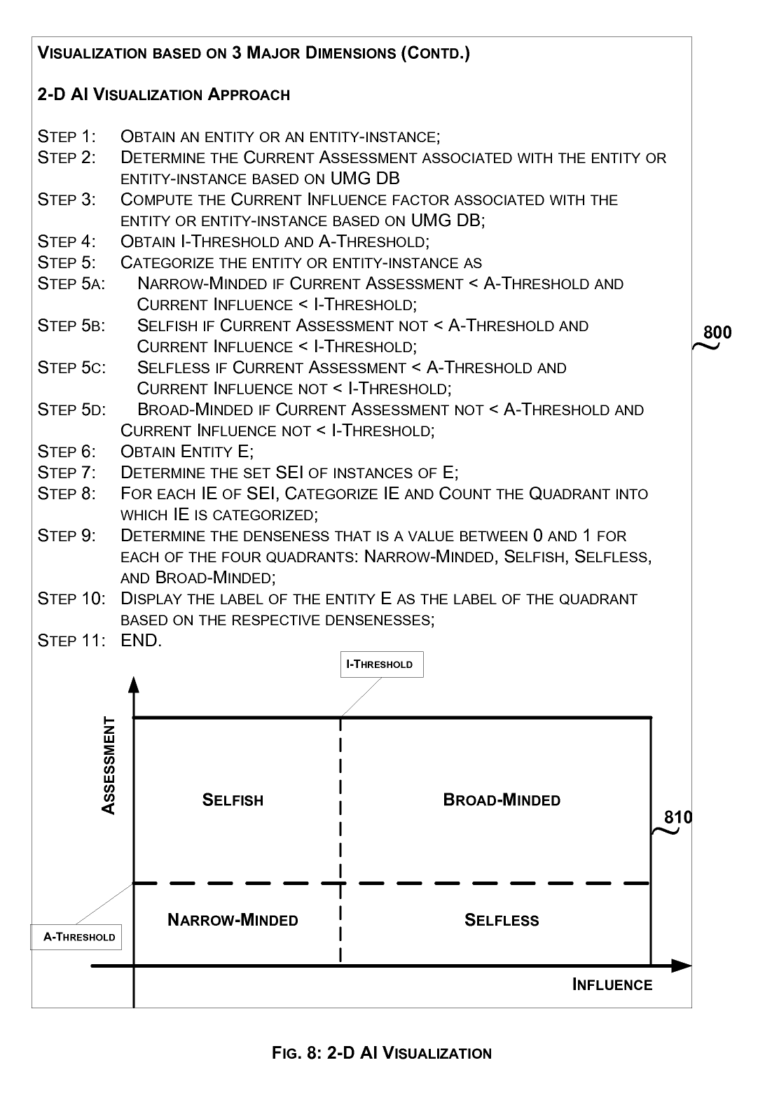

FIG. 8 describes an approach for 2-D Visualization based on Assessment (A) and Influence (I) Values. Visualization based on 3 Major Dimensions (Contd.)

Means and approach for 2-D AI Visualization (800):
Step 1: Obtain an entity or an entity-instance;
Step 2: Determine the Current Assessment associated with the entity or entity-instance based on UMG DB
Step 3: Compute the Current Influence factor associated with the entity or entity-instance based on UMG DB;
Step 4: Obtain I-Threshold and A-Threshold;
Step 5: Categorize the entity or entity-instance as
Step 5a: Narrow-Minded if Current Assessment<A-Threshold and
   Current Influence<I-Threshold;
Step 5b: Selfish if Current Assessment not <A-Threshold and
   Current Influence<I-Threshold;
Step 5c: Selfless if Current Assessment<A-Threshold and
   Current Influence not <I-Threshold;
Step 5d: Broad-Minded if Current Assessment not <A-Threshold and Current Influence not <I-Threshold;
Step 6: Obtain Entity E;
Step 7: Determine the set SEI of instances of E;
Step 8: For each IE of SEI, Categorize IE and Count the Quadrant into which IE is categorized;
Step 9: Determine the denseness that is a value between 0 and 1 for each of the four quadrants: Narrow-Minded, Selfish, Selfless, and Broad-Minded;
Step 10: Display the label of the entity E as the label of the quadrant based on the respective densenesses;
Step 11: END.

810 provides a depiction of the four quadrants. The lower left quadrant is labeled “Narrow-Minded,” the upper left quadrant is labeled “Selfish,” the lower right quadrant is labeled “Selfless,” and the magic quadrant is the upper right quadrant that is labeled “Broad-Minded.” Note that these quadrants are defined based on two threshold values, namely, A-Threshold and I-Threshold.

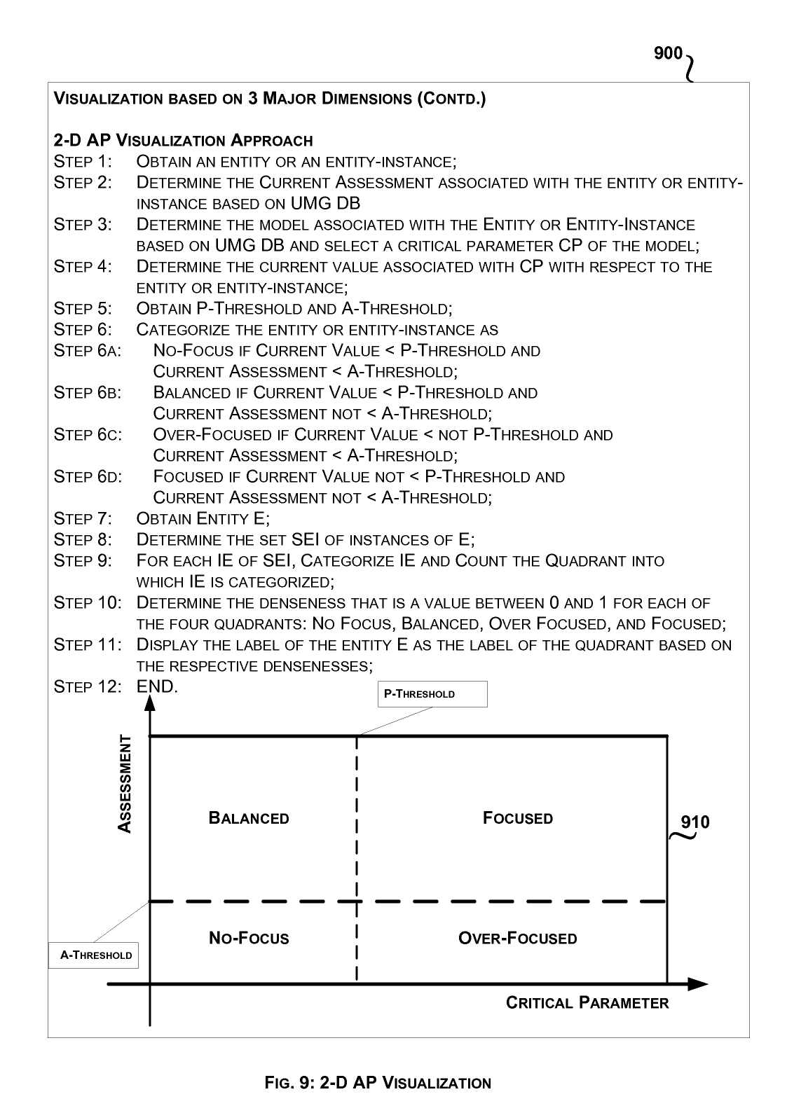

FIG. 9 describes an approach for 2-D Visualization based on Assessment (A) and Critical Parameter (P) Values.

Visualization based on 3 Major Dimensions (Contd.)

Means and approach for 2-D AP Visualization (900):
Step 1: Obtain an entity or an entity-instance;
Step 2: Determine the Current Assessment associated with the entity or entity-instance based on UMG DB
Step 3: Determine the model associated with the Entity or Entity-Instance based on UMG DB and select a critical parameter CP of the model;
Step 4: Determine the current value associated with CP with respect to the entity or entity-instance;
Step 5: Obtain P-Threshold and A-Threshold; Step 6: Categorize the entity or entity-instance as
Step 6a: No-Focus if Current Value<P-Threshold and
   Current Assessment<A-Threshold;
Step 6b: Balanced if Current Value<P-Threshold and
   Current Assessment not <A-Threshold;
Step 6c: Over-Focused if Current Value<not P-Threshold and
   Current Assessment<A-Threshold;
Step 6d: Focused if Current Value not <P-Threshold and
   Current Assessment not <A-Threshold;
Step 7: Obtain Entity E;
Step 8: Determine the set SEI of instances of E;
Step 9: For each IE of SEI, Categorize IE and Count the Quadrant into which IE is categorized;
Step 10: Determine the denseness that is a value between 0 and 1 for each of the four quadrants: No Focus, Balanced, Over Focused, and Focused;
Step 11: Display the label of the entity E as the label of the quadrant based on the respective densenesses;
Step 12: END.

910 provides a depiction of the four quadrants. The lower left quadrant is labeled “No-Focus,” the upper left quadrant is labeled “Balanced,” the lower right quadrant is labeled “Over-Focused,” and the magic quadrant is the upper right quadrant that is labeled “Focused.” Note that these quadrants are defined based on two threshold values, namely, A-Threshold and P-Threshold.

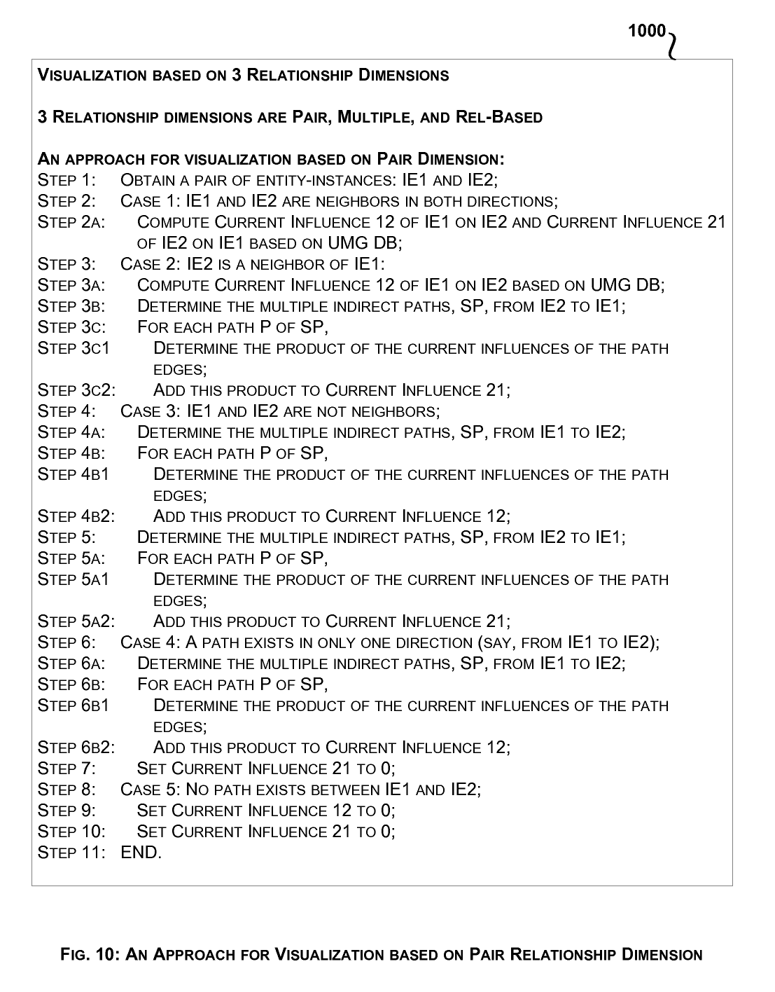

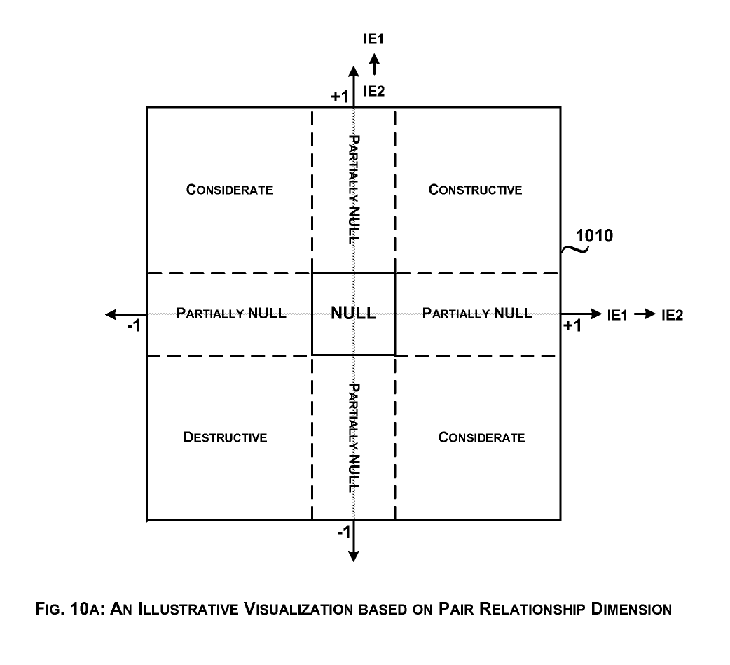

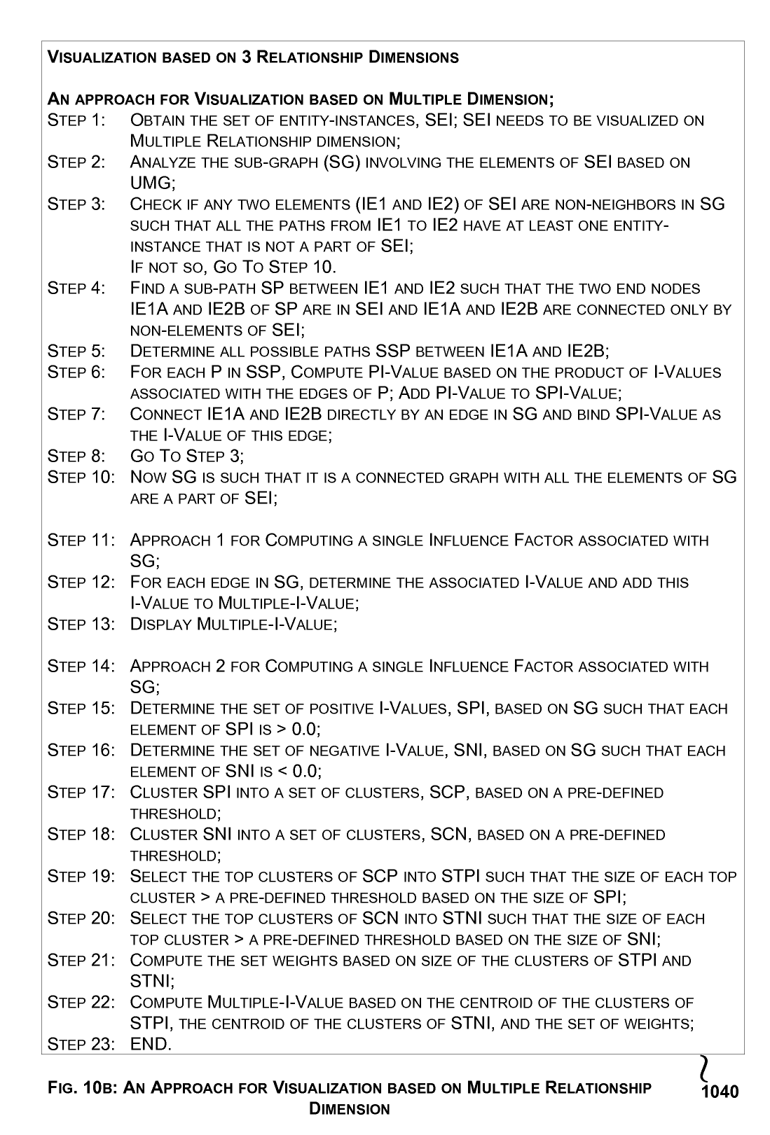

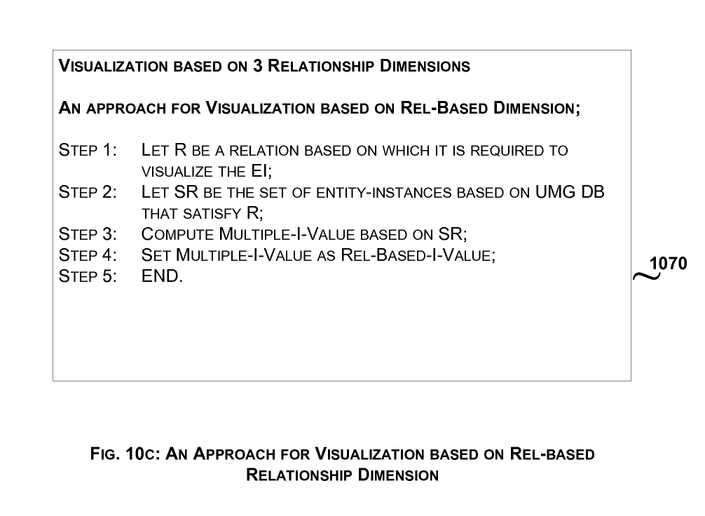

FIG. 10 describes an approach for Visualization based on Pair Relationship Dimension. Visualization based on 3 Relationship Dimensions

3 Relationship dimensions are Pair, Multiple, and Rel-Based

Means and approach for visualization based on Pair Dimension (1000):
Step 1: Obtain a pair of entity-instances: IE1 and IE2;
Step 2: Case 1: IE1 and IE2 are neighbors in both directions;
Step 2a: Compute Current Influence 12 of IE1 on IE2 and Current Influence 21 of IE2 on IE1 based on UMG DB;
Step 3: Case 2: IE2 is a neighbor of IE1:
Step 3a: Compute Current Influence 12 of IE1 on IE2 based on UMG DB;
Step 3b: Determine the multiple indirect paths, SP, from IE2 to IE1;
Step 3c: For each path P of SP,
Step 3c1 Determine the product of the current influences of the path edges;
Step 3c2: Add this product to Current Influence 21;
Step 4: Case 3: IE1 and IE2 are not neighbors;
Step 4a: Determine the multiple indirect paths, SP, from IE1 to IE2;
Step 4b: For each path P of SP,
Step 4b1 Determine the product of the current influences of the path edges;
Step 4b2: Add this product to Current Influence 12;
Step 5: Determine the multiple indirect paths, SP, from IE2 to IE1;
Step 5a: For each path P of SP,
Step 5a1 Determine the product of the current influences of the path edges;
Step 5a2: Add this product to Current Influence 21;
Step 6: Case 4: A path exists in only one direction (say, from IE1 to IE2);
Step 6a: Determine the multiple indirect paths, SP, from IE1 to IE2;
Step 6b: For each path P of SP,
Step 6b1 Determine the product of the current influences of the path edges;
Step 6b2: Add this product to Current Influence 12;
Step 7: Set Current Influence 21 to 0;
Step 8: Case 5: No path exists between IE1 and IE2;
Step 9: Set Current Influence 12 to 0;
Step 10: Set Current Influence 21 to 0;
Step 11: END.

FIG. 10a provides an illustrative Visualization based on Pair Relationship Dimension. In this illustration (1010), X-axis denotes the quantum of influence of IE1 on IE2 and Y-axis denotes the quantum of influence of IE2 on IE1. Close to origin, denotes a very low level influence of two entity-instances on each other and this close region is denoted as a NULL region. Similarly, the regions close to the two axes denote PARTIALLY NULL regions. The region wherein both entity-instances positively influence each other is denoted as CONSTRUCTIVE while the region wherein both entity-instances negatively influence each other is denoted as DESTRUCTIGVE; The other two regions, wherein one of the entity-instances positively influences the other, and the other negatively is labeled CONSIDERATE.

FIG. 10b describes an approach for Visualization based on Multiple Relationship Dimension. Visualization based on 3 Relationship Dimensions

Means and approach for Visualization based on Multiple Dimension (1040):
Step 1: Obtain the set of entity-instances, SEI; SEI needs to be visualized on Multiple Relationship dimension;
Step 2: Analyze the sub-graph (SG) involving the elements of SEI based on UMG;
Step 3: Check if any two elements (IE1 and IE2) of SEI are non-neighbors in SG such that all the paths from IE1 to IE2 have at least one entity-instance that is not a part of SEI;
   If not so, Go To Step 10.
Step 4: Find a sub-path SP between IE1 and IE2 such that the two end nodes IE1A and IE2B of SP are in SEI and IE1A and IE2B are connected only by non-elements of SEI;
Step 5: Determine all possible paths SSP between IE1A and IE2B;
Step 6: For each P in SSP, Compute PI-Value based on the product of I-Values associated with the edges of P; Add PI-Value to SPI-Value;
Step 7: Connect IE1A and IE2B directly by an edge in SG and bind SPI-Value as the I-Value of this edge;
Step 8: Go To Step 3;
Step 10: Now SG is such that it is a connected graph with all the elements of SG are a part of SEI;
Step 11: Approach 1 for Computing a single Influence Factor associated with SG;
Step 12: For each edge in SG, determine the associated I-Value and add this I-Value to Multiple-I-Value;
Step 13: Display Multiple-I-Value;
Step 14: Approach 2 for Computing a single Influence Factor associated with SG;
Step 15: Determine the set of positive I-Values, SPI, based on SG such that each element of SPI is >0.0;
Step 16: Determine the set of negative I-Value, SNI, based on SG such that each element of SNI is <0.0;
Step 17: Cluster SPI into a set of clusters, SCP, based on a pre-defined threshold;
Step 18: Cluster SNI into a set of clusters, SCN, based on a pre-defined threshold;
Step 19: Select the top clusters of SCP into STPI such that the size of each top cluster>a pre-defined threshold based on the size of SPI;
Step 20: Select the top clusters of SCN into STNI such that the size of each top cluster>a pre-defined threshold based on the size of SNI;
Step 21: Compute the set weights based on size of the clusters of STPI and STNI;
Step 22: Compute Multiple-I-Value based on the centroid of the clusters of STPI, the centroid of the clusters of STNI, and the set of weights;
Step 23: END.

FIG. 10c describes an approach for Visualization based on Rel-based Relationship Dimension. Visualization based on 3 Relationship Dimensions

Means and approach for Visualization based on Rel-Based Dimension (1070):
Step 1: Let R be a relation based on which it is required to visualize the EI;
Step 2: Let SR be the set of entity-instances based on UMG DB that satisfy R;
Step 3: Compute Multiple-I-Value based on SR;
Step 4: Set Multiple-I-Value as Rel-Based-I-Value;
Step 5: END.

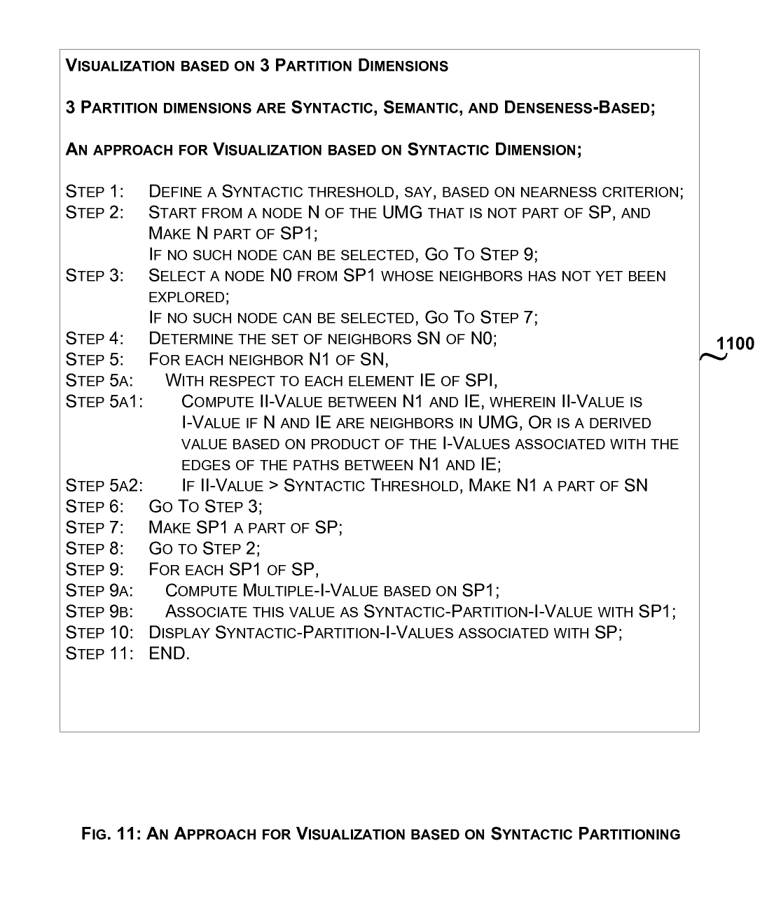

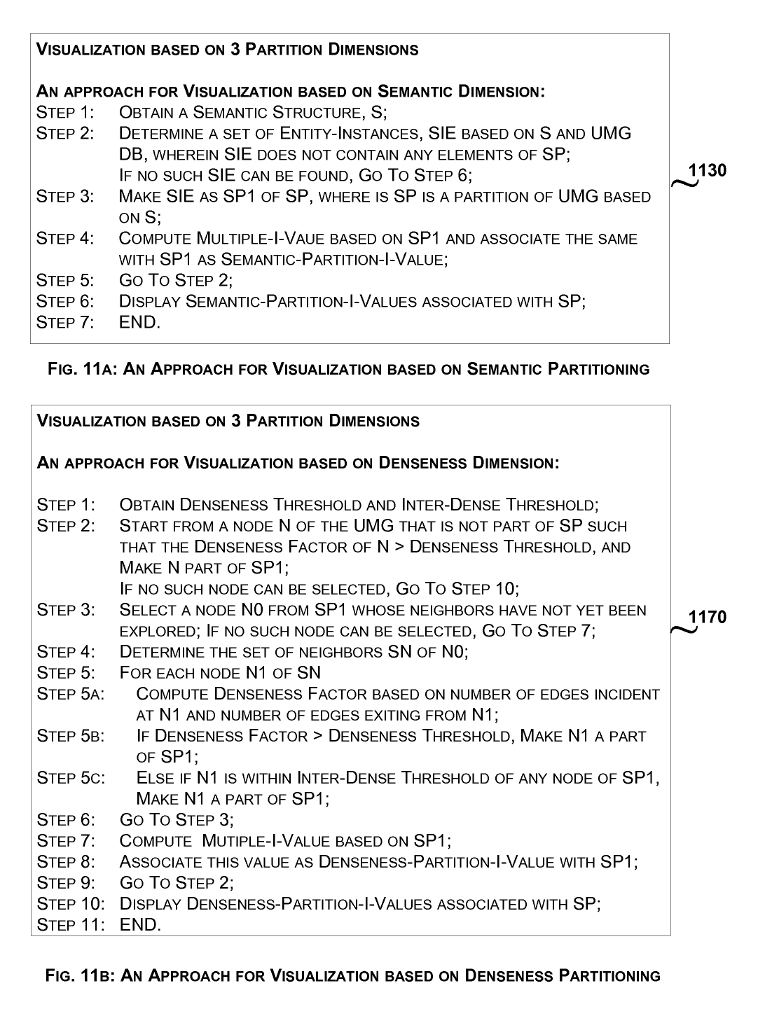

FIG. 11 describes an approach for Visualization based on Syntactic Partitioning.

Visualization based on 3 Partition Dimensions

3 Partition dimensions are Syntactic, Semantic, and Denseness-Based;

Means and approach for Visualization based on Syntactic Dimension (1100):
Step 1: Define a Syntactic threshold, say, based on nearness criterion;
Step 2: Start from a node N of the UMG that is not part of SP, and Make N part of SP1;
   If no such node can be selected, Go To Step 9;
Step 3: Select a node NO from SP1 whose neighbors has not yet been explored;
   If no such node can be selected, Go To Step 7;
Step 4: Determine the set of neighbors SN of N0;
Step 5: For each neighbor N1 of SN,
Step 5a: With respect to each element IE of SPI,
Step 5a1: Compute II-Value between N1 and IE, wherein II-Value is I-Value if N and IE are neighbors in UMG, Or is a derived value based on product of the I-Values associated with the edges of the paths between N1 and IE;
Step 5a2: If II-Value>Syntactic Threshold, Make N1 a part of SN
Step 6: Go To Step 3;
Step 7: Make SP1 a part of SP;
Step 8: Go to Step 2;
Step 9: For each SP1 of SP,
Step 9a: Compute Multiple-I-Value based on SP1;
Step 9b: Associate this value as Syntactic-Partition-I-Value with SP1;
Step 10: Display Syntactic-Partition-I-Values associated with SP;
Step 11: END.

FIG. 11a describes an approach for Visualization based on Semantic Partitioning.

Visualization based on 3 Partition Dimensions

Means and approach for Visualization based on Semantic Dimension (1130):
Step 1: Obtain a Semantic Structure, 5;
Step 2: Determine a set of Entity-Instances, SIE based on S and UMG DB, wherein SIE does not contain any elements of SP;
   If no such SIE can be found, Go To Step 6;
Step 3: Make SIE as SP1 of SP, where is SP is a partition of UMG based on 5;
Step 4: Compute Multiple-I-Value based on SP1 and associate the same with SP1 as Semantic-Partition-I-Value;
Step 5: Go To Step 2;
Step 6: Display Semantic-Partition-I-Values associated with SP;
Step 7: END.

FIG. 11b describes an approach for Visualization based on Denseness Partitioning.

Visualization based on 3 Partition Dimensions

Means and approach for Visualization based on Denseness Dimension (1170):
Step 1: Obtain Denseness Threshold and Inter-Dense Threshold;
Step 2: Start from a node N of the UMG that is not part of SP such that the Denseness Factor of N>Denseness Threshold, and Make N part of SP1;
   If no such node can be selected, Go To Step 10;
Step 3: Select a node NO from SP1 whose neighbors have not yet been explored;
   If no such node can be selected, Go To Step 7;
Step 4: Determine the set of neighbors SN of NO;
Step 5: For each node N1 of SN
Step 5a: Compute Denseness Factor based on number of edges incident at N1 and number of edges exiting from N1;
Step 5b: If Denseness Factor>Denseness Threshold, Make N1 a part of SP1;
Step 5c: Else if N1 is within Inter-Dense Threshold of any node of SP1,
   Make N1 a part of SP1;
Step 6: Go To Step 3;
Step 7: Compute Multiple-I-Value based on SP1;
Step 8: Associate this value as Denseness-Partition-I-Value with SP1;
Step 9: Go To Step 2;
Step 10: Display Denseness-Partition-I-Values associated with SP;
Step 11: END.

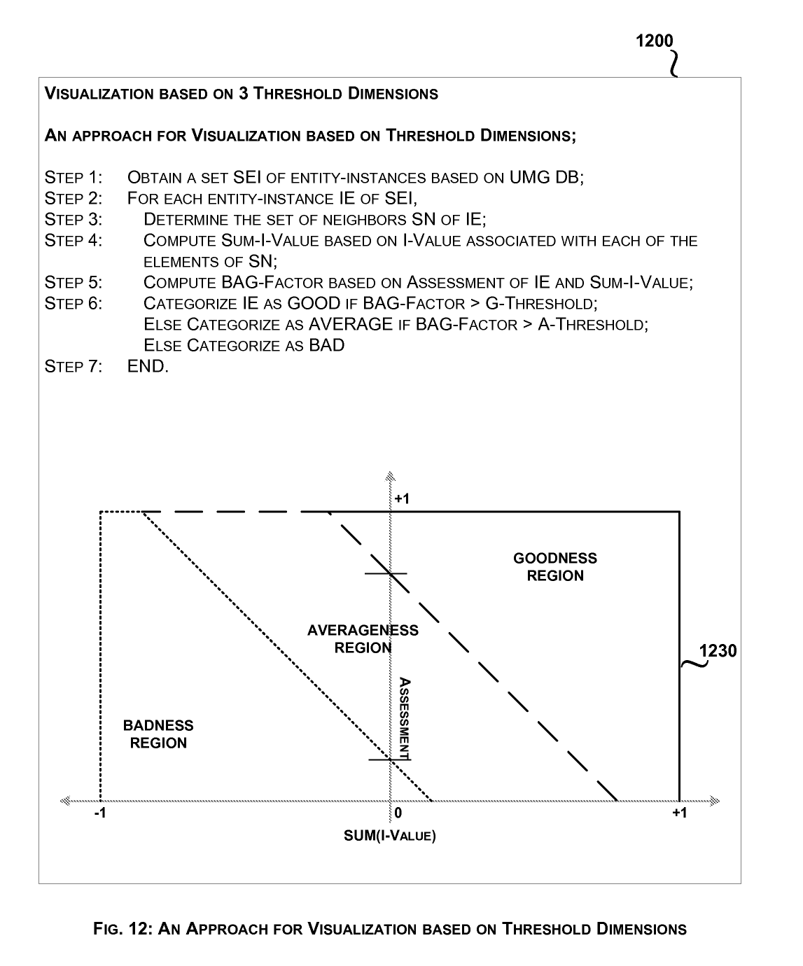

FIG. 12 describes an approach for Visualization based on Threshold Dimensions.

Visualization based on 3 Threshold Dimensions

Means and approach for Visualization based on Threshold Dimensions (1200):
Step 1: Obtain a set SEI of entity-instances based on UMG DB;
Step 2: For each entity-instance IE of SEI,
Step 3: Determine the set of neighbors SN of IE;
Step 4: Compute Sum-I-Value based on I-Value associated with each of the elements of SN;
Step 5: Compute BAG-Factor based on Assessment of IE and Sum-I-Value;
Step 6: Categorize IE as GOOD if BAG-Factor>G-Threshold;
   Else Categorize as AVERAGE if BAG-Factor>A-Threshold;
   Else Categorize as BAD
Step 7: END.

1230 provides an illustrative visualization of UMG data based on threshold dimensions. The X-axis denotes the sum of I-Values and Y-axis denotes the assessment of the entity-instance under consideration. The visualization depicts three regions, namely, Badness region, Averageness region, and Goodness region.

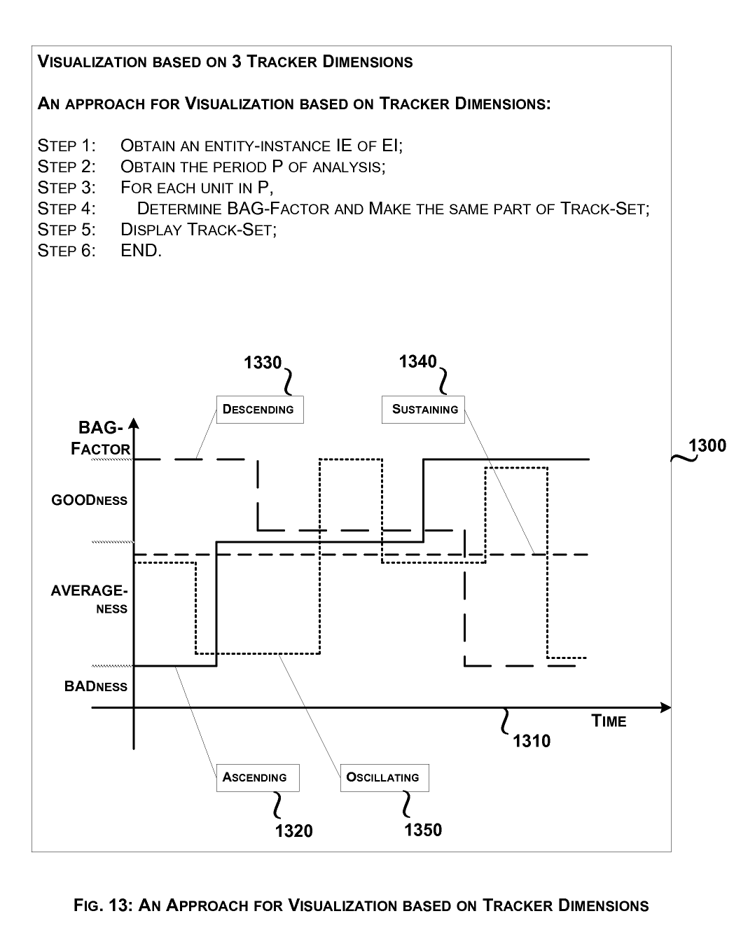

FIG. 13 describes an approach for Visualization based on Tracker Dimensions.

Visualization based on 3 Tracker Dimensions

Means and approach for Visualization based on Tracker Dimensions (1300):
Step 1: Obtain an entity-instance IE of EI;
Step 2: Obtain the period P of analysis;
Step 3: For each unit in P,
Step 4: Determine BAG-Factor and Make the same part of Track-Set;
Step 5: Display Track-Set;
Step 6: END.

1310 provides a depiction of a visualization based on tracker dimensions. X-axis denotes Time while the Y-Axis denotes BAG-Factor. The Bag-Factor computed for an entity-instance over a period of time is visualized along with X-Y axes: 1320 depicts an Ascending Bag-factor while 1330 depicts a Descending one. 1340 shows a Sustaining Bag-factor and 1350 shows an Oscillating characterization of an entity-instance.

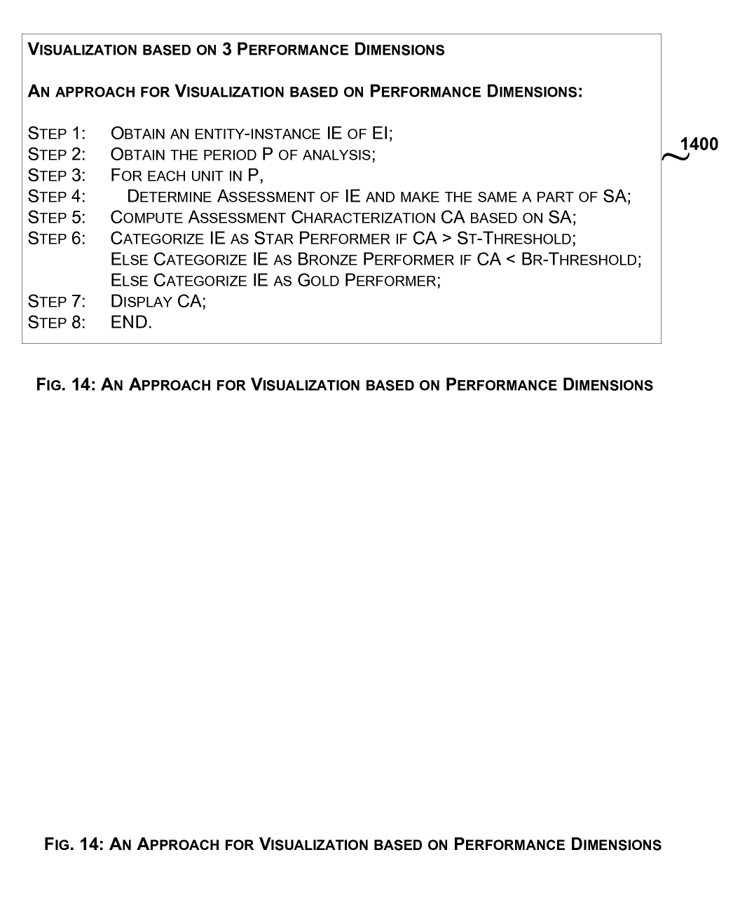

FIG. 14 describes an approach for Visualization based on Performance Dimensions.

Visualization based on 3 Performance Dimensions

Means and approach for Visualization based on Performance Dimensions (1400):
Step 1: Obtain an entity-instance IE of EI;
Step 2: Obtain the period P of analysis;
Step 3: For each unit in P,
Step 4: Determine Assessment of IE and make the same a part of SA;
Step 5: Compute Assessment Characterization CA based on SA;
Step 6: Categorize IE as Star Performer if CA>St-Threshold;
   Else Categorize IE as Bronze Performer if CA<Br-Threshold;
   Else Categorize IE as Gold Performer;
Step 7: Display CA;
Step 8: END.

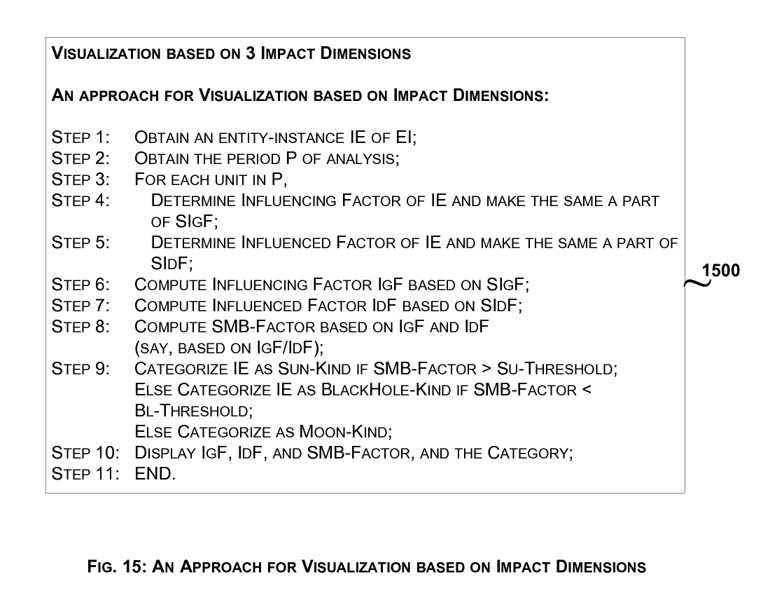

FIG. 15 describes an approach for Visualization based on Impact Dimensions.

Visualization based on 3 Impact Dimensions

Means and approach for Visualization based on Impact Dimensions (1500):
Step 1: Obtain an entity-instance IE of EI;
Step 2: Obtain the period P of analysis;
Step 3: For each unit in P,
Step 4: Determine Influencing Factor of IE and make the same a part of SIgF;
Step 5: Determine Influenced Factor of IE and make the same a part of SIdF;
Step 6: Compute Influencing Factor IgF based on SIgF;
Step 7: Compute Influenced Factor IdF based on SIdF;
Step 8: Compute SMB-Factor based on IgF and IdF (say, based on IgF/IdF);
Step 9: Categorize IE as Sun-Kind if SMB-Factor>Su-Threshold;
   Else Categorize IE as BlackHole-Kind if SMB-Factor<BI-Threshold;
   Else Categorize as Moon-Kind;
Step 10: Display IgF, IdF, and SMB-Factor, and the Category;
Step 11: END.

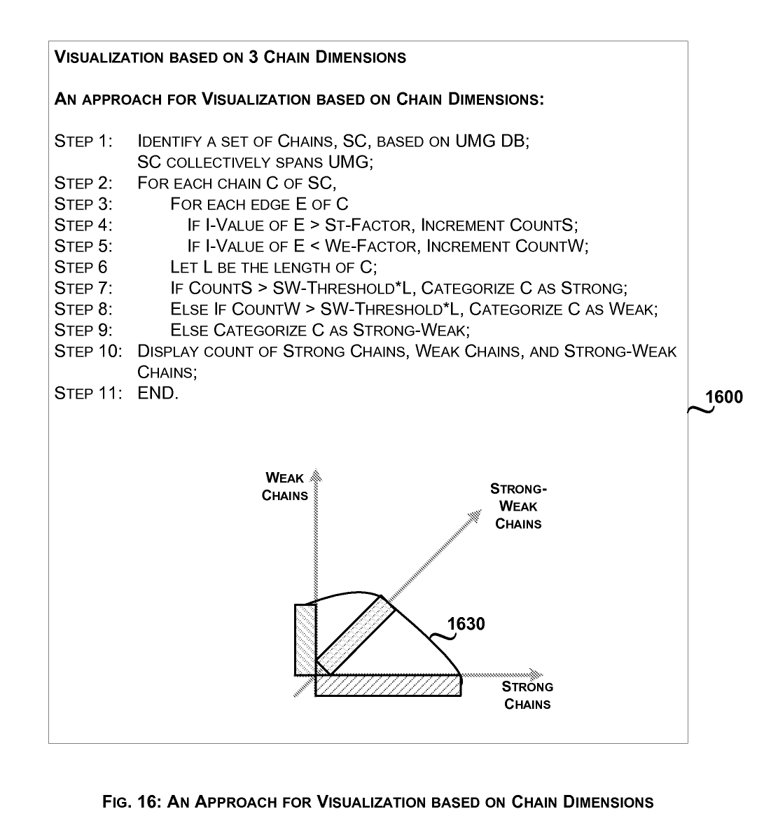

FIG. 16 describes an approach for Visualization based on Chain Dimensions.

Visualization based on 3 Chain Dimensions

Means and approach for Visualization based on Chain Dimensions:
Step 1: Identify a set of Chains, SC, based on UMG DB;
   SC collectively spans UMG;
Step 2: For each chain C of SC,
Step 3: For each edge E of C
Step 4: If I-Value of E>St-Factor, Increment CountS;
Step 5: If I-Value of E<We-Factor, Increment CountW;
Step 6 Let L be the length of C;
Step 7: If CountS>SW-Threshold*L, Categorize C as Strong;
Step 8: Else If CountW>SW-Threshold*L, Categorize C as Weak;
Step 9: Else Categorize C as Strong-Weak;
Step 10: Display count of Strong Chains, Weak Chains, and Strong-Weak Chains;
Step 11: END.

1630 depicts a visualization based on chain dimension. Here, X-axis denotes Strong Chains while Y-axis denotes Weak Chains; The count of chains that are neither comprehensively strong nor comprehensively weak is denoted along an axis in between X-axis and Y-axis as depicted.

Thus, a system and method for the visualization based on a university model graph of a university is disclosed. Although the present invention has been described particularly with reference to the figures, it will be apparent to one of the ordinary skill in the art that the present invention may appear in any number of systems that provide visualization of influence based structural representation. It is further contemplated that many changes and modifications may be made by one of ordinary skill in the art without departing from the spirit and scope of the present invention.

We claim:

1. A system for a university model graph based visualization of the information about a university with the help of a plurality of assessments and a plurality of influence values contained in a university model graph database to help in providing an effective understanding of said university at multiple levels,
said university having a plurality of entities and a plurality of entity-instances, wherein each of said plurality of entity-instances is an instance of an entity of said plurality of entities, and
said university model graph having a plurality of models, a plurality of abstract nodes, a plurality of nodes, a plurality of abstract edges, a plurality of semi-abstract edges, and a plurality of edges, with each abstract node of said plurality of abstract nodes corresponding to an entity of said plurality of entities,
each node of said plurality of nodes corresponding to an entity-instance of said plurality of entity-instances, and
each abstract node of said plurality of abstract nodes is associated with a model of said plurality of models, and
a node of said plurality of nodes is connected to an abstract node of said plurality of abstract nodes through an abstract edge of said plurality of abstract edges, wherein said node represents an instance of an entity associated with said abstract node and said node is associated with an instantiated model and a base score, wherein said instantiated model is based on a model associated with said abstract node, and said base score is computed based on said instantiated model and is a value between 0 and 1,
a source abstract node of said plurality of abstract nodes is connected to a destination abstract node of said plurality of abstract nodes by a directed abstract edge of said plurality of abstract edges and said directed abstract edge is associated with an entity influence value of said plurality of influence values, wherein said entity influence value is a value between −1 and +1;
a source node of said plurality of nodes is connected to a destination node of said plurality of nodes by a directed edge of said plurality of edges and said directed edge is associated with an influence value of said plurality influence values, wherein said influence value is a value between −1 and +1;
a source node of said plurality of nodes is connected to a destination abstract node of said plurality of abstract nodes by a directed semi-abstract edge of said plurality of semi-abstract edges and said directed semi-abstract edge is associated with an entity-instance-entity-influence value of said plurality influence values, wherein said influence value is a value between −1 and +1; and
a source abstract node of said plurality of abstract nodes is connected to a destination node of said plurality of nodes by a directed semi-abstract edge of said plurality of semi-abstract edges and said directed semi-abstract edge is associated with an entity-entity-instance-influence value of said plurality influence values, wherein said influence value is a value between −1 and +1, said system comprising,
means for providing of visualization of said university model graph of said university based on a three major dimensions consisting of an assessment dimension, an influence dimension, and a parametric dimension;
means for providing of visualization of said university model graph of said university based on a three minor dimensions consisting of an abstract view dimension, a details view dimension, and a variations view dimension;
means for providing of visualization of said university model graph of said university based on a three relationship dimensions consisting of a pair level dimension, a multiple level dimension, and a rel-based dimension;
means for providing of visualization of said university model graph of said university based on a three partition dimensions consisting of a syntactic partition dimension, a semantic partition dimension, and a denseness based partitioning;
means for providing of visualization of said university model graph of said university based on a three threshold dimensions consisting of a goodness dimension, an averageness dimension, and a badness dimension;
means for providing of visualization of said university model graph of said university based on a three tracker dimensions consisting of an ascending behavior dimension, a descending behavior dimension, and a sustaining behavior dimension;
means for providing of visualization of said university model graph of said university based on a three performance dimensions consisting of a star performer dimension, a gold performer dimension, and a bronze performer dimension;
means for providing of visualization of said university model graph of said university based on a three impact dimensions consisting of a sun-kind impact dimension, a moon-kind impact dimension, and a blackhole-kind impact dimension; and
means for providing of visualization of said university model graph of said university based on a three chain dimensions consisting of a strong chain dimension, a weak chain dimension, and a strong-weak chain dimension.
(BASED ON FIGS. 1, 1a, 1b, 2, and 3)

2. The system as claimed in claim 1, wherein said means for providing of visualization of said university model graph of said university based on said three major dimensions further comprises:
means for a one-dimensional assessment visualization;
means for a one-dimensional influence visualization;
means for a one-dimensional parametric visualization;
means for a two-dimensional assessment-influence visualization; and
means for a two-dimensional assessment—parametric visualization.
(BASED ON FIG. 4)

3. The system as claimed in claim 2, wherein said means for said one-dimensional assessment visualization further comprises:
means for obtaining of an entity of said plurality of entities;
means for obtaining of an entity-instance of said plurality of entity-instances;
means for determining of a current assessment of said entity or said entity-instance based on said university model graph database for providing said abstract view of said three minor dimensions;
means for obtaining of a periodicity;
means for determining of a plurality of data values associated with said entity or said entity-instance based on said university model graph database;
means for computing of a plurality of data sets based on said plurality of data values and said periodicity;
means for obtaining of a data set of said plurality data sets;
means for computing of a plurality of clusters of said data set;
means for determining of a size of said data set;
means for selecting of a plurality of top clusters based on said plurality of clusters and a pre-defined threshold based on said size;
means for computing of a plurality of weights based on a size of each of said plurality of top clusters;
means for computing of a periodic assessment based on a centroid of each of said plurality of top clusters and said plurality of weights;
means for updating of a plurality of periodic assessments based on said periodic assessment;
means for computing of a plurality of predicted assessments based on said plurality of periodic assessments and a pre-defined threshold;
means for updating of said plurality f periodic assessments based on said plurality of predicted assessments;
means for obtaining of a time period;
means for determining of a plurality of assessment variations based said university model graph database and said time period;
means for computing of a plurality of predicted assessment variations based on said plurality of assessment variations and a pre-defined threshold;
means for updating of said plurality of assessment variations based on said plurality of predicted assessment variations;
means for displaying of said current assessment for providing said abstract view of said three minor dimensions;
means for displaying of said plurality of periodic assessments for providing said details view of said three minor dimensions; and
means for displaying of said plurality of assessment variations for providing said variations view of said three minor dimensions.
(BASED ON FIG. 5)

4. The system as claimed in claim 2, wherein said means for said one-dimensional influence visualization further comprises:
means for obtaining of an entity of said plurality of entities;
means for obtaining of an entity-instance of said plurality of entity-instances;
means for determining of a plurality of entity influence values of said entity or said entity-instance;
means for determining of a plurality of entity-instance influence values of said entity or said entity-instance;
means for determining of a plurality of entity influenced values of said entity or said entity-instance;
means for determining of a plurality of entity-instance influenced values of said entity or said entity-instance;
means for computing of a plurality of positive clusters of said plurality of entity influence values;
means for computing of a plurality of negative clusters of said plurality of entity influence values;
means for selecting of a plurality of top positive clusters based on said plurality of positive clusters and a pre-defined threshold based on a size of said plurality of entity influence values;
means for selecting of a plurality of top negative clusters based on said plurality of negative clusters and a pre-defined threshold based on a size of said plurality of entity influence values;
means for computing of a plurality of weights based on a size of each of said plurality of top positive clusters and a size of each of said plurality of top negative clusters;
means for computing of a current influence based on a centroid of each of said plurality of top positive clusters, a centroid of each of said plurality of top negative clusters, and said plurality of weights;
means for making of said current influence a part of a plurality of current influences;
means for computing of a plurality of influence weights based on said plurality of entity influence values, said plurality of entity-influence values, said plurality of entity influenced values, and said plurality of entity-instance influenced values;
means for computing of an overall influence value based on said plurality of current influences and said plurality of influence weights;
means for obtaining of a periodicity;
means for determining of a plurality of data values based on an entity influence value associated with said entity or said entity-instance;
means for computing of a plurality of data sets based on said plurality of data values and said periodicity;
means for obtaining of a data set of said plurality data sets;
means for obtaining of an entity influence value set of said data set;
means for computing of an entity influence factor based on said entity influence value set;
means for making of said entity influence factor a part of a plurality of entity influence factors;
means for computing of a periodic entity influence factor based on said plurality of entity influence factors;
means for making of said periodic entity influence factor a part of a plurality of periodic entity influence factors;
means for computing of a plurality of predicted entity influence factors based on said plurality of periodic entity influence factors and a pre-defined threshold;
means for updating of said plurality of periodic entity influence factors based on said plurality of predicted entity influence factors;
means for computing of a plurality of periodic entity-instance influence factors;
means for computing of a plurality of periodic entity influenced factors;
means for computing of a plurality of periodic entity-instance influenced factors;
means for obtaining of a time period;
means for computing of a plurality of entity influence factor variations based on said university model graph database and said time period;
means for computing of a plurality of predicted entity influence factor variations based on said plurality of entity influence factor variations;
means for updating of said plurality of entity influence factor variations based said plurality of predicted entity influence factor variations;
means for computing of a plurality of entity-instance influence factor variations based on said university model graph database and said time period;
means for computing of a plurality of predicted entity-instance influence factor variations based on said plurality of entity-instance influence factor variations;
means for updating of said plurality of entity-instance influence factor variations based said plurality of predicted entity-instance influence factor variations;
means for computing of a plurality of entity influenced factor variations based on said university model graph database and said time period;
means for computing of a plurality of predicted entity influenced factor variations based on said plurality of entity influenced factor variations;
means for updating of said plurality of entity influenced factor variations based said plurality of predicted entity influenced factor variations;
means for computing of a plurality of entity-instance influenced factor variations based on said university model graph and said time period;
means for computing of a plurality of predicted entity-instance influenced factor variations based on said plurality of entity-instance influenced factor variations;
means for updating of said plurality of entity-instance influenced factor variations based said plurality of predicted entity-instance influenced factor variations;
means for displaying of said overall influence value for providing said abstract view of said three minor dimensions;
means for displaying of said of said plurality of periodic entity influence factors, said plurality of periodic entity-instance influence factors, said plurality of periodic entity influenced factors, and said plurality of periodic entity-instance influenced factors for providing said details view of said three minor dimensions; and
means for displaying of said plurality of entity influence factor variations, said plurality of entity-instance influence factor variations, said plurality of entity influenced factor variations, and said plurality of entity-instance influenced factor variations for providing said variations view of said three minor dimensions.
(BASED ON FIG. 6)

5. The system as claimed in claim 2, wherein said means for said one-dimensional parametric visualization further comprises:
means for obtaining of an entity of said plurality of entities;
means for obtaining of an entity-instance of said plurality of entity-instances;
means for determining of a model of said plurality of models associated with said entity or said entity-instance;
means for determining of a critical parameter of a plurality of parameters associated with said model;
means for determining of a current critical parameter value of said critical parameter based on said entity or said entity-instance, and said university model graph database for providing said abstract view of said three minor dimensions;
means for obtaining of a periodicity;
means for determining of a plurality of data values associated with said critical parameter and said entity or said entity-instance based on said university model graph database;
means for computing of a plurality of data sets based on said plurality of data values and said periodicity;
means for obtaining of a data set of said plurality data sets;
means for computing of a plurality of clusters of said data set;
means for determining of a size of said data set;
means for selecting of a plurality of top clusters based on said plurality of clusters and a pre-defined threshold based on said size;
means for computing of a plurality of weights based on a size of each of said plurality of top clusters;
means for computing of a periodic critical parameter value based on a centroid of each of said plurality of top clusters and said plurality of weights;
means for updating of a plurality of periodic critical parameter values based on said periodic critical parameter value;
means for computing of a plurality of predicted critical parameter values based on said plurality of periodic critical parameter values and a pre-defined threshold;
means for updating of said plurality of periodic critical parameter values based on said plurality of predicted critical parameter values;
means for obtaining of a time period;
means for determining of a plurality of critical parameter value variations based said university model graph database and said time period;
means for computing of a plurality of predicted critical parameter value variations based on said plurality of critical parameter value variations and a pre-defined threshold;
means for updating of said plurality of critical parameter value variations based on said plurality of predicted critical parameter value variations;
means for displaying of said current critical parameter value for providing said abstract view of said three minor dimensions;
means for displaying of said plurality of periodic critical parameter values for providing said details view of said three minor dimensions; and
means for displaying of said plurality of critical parameter value variations for providing said variations view of said three minor dimensions.
(BASED ON FIG. 7)

6. The system as claimed in claim 2, wherein said means for said two-dimensional assessment-influence visualization further comprises:
means for obtaining of an entity of said plurality of entities;
means for obtaining of an entity-instance of said plurality of entity-instances;
means for determining of a current assessment associated with said entity or said entity-instance based on said university model graph database;
means for determining of a current influence factor associated with said entity or said entity-instance based on said university model graph database;
means for obtaining of an I-Threshold;
means for obtaining of an A-Threshold;
means for categorizing of said entity or said entity-instance with a label as narrow-minded if said current assessment is <said A-Threshold and said current influence factor is <said I-Threshold;
means for categorizing of said entity or said entity-instance with a label as selfish if said current assessment is not <said A-Threshold and said current influence factor is <said I-Threshold;
means for categorizing of said entity or said entity-instance with a label as selfless if said current assessment <said A-Threshold and said current influence factor is not <said I-Threshold;
means for categorizing of said entity or said entity-instance with a label as broad-minded if said current assessment is not <said A-Threshold and said current influence factor is not <said I-Threshold;
means for determining of a plurality of entity-instances of said entity;
means for categorizing of each of said plurality of entity-instances into one of narrow-minded quadrant, selfish quadrant, selfless quadrant, and broad-minded quadrant;
means for computing of a plurality of denseness factors associated with narrow-minded quadrant, selfish quadrant, selfless quadrant, and broad-minded quadrant;
means for labeling of said entity with an abstract label based on said plurality of denseness factors; and
means for displaying of said label and said abstract label for providing said two-dimensional assessment-influence visualization.
(BASED ON FIG. 8)

7. The system as claimed in claim 2, wherein said means for said two-dimensional assessment-parametric visualization further comprises:
means for obtaining of an entity of said plurality of entities;
means for obtaining of an entity-instance of said plurality of entity-instances;
means for determining of a current assessment associated with said entity or said entity-instance based on said university model graph database;
means for determining of a model of said plurality of models associated with said entity or said entity-instance;
means for selecting of a critical parameter of a plurality of parameters associated with said model;
means for determining of a current critical parameter value associated with said model based on said entity or said entity-instance, and said university model graph database;
means for obtaining of a P-Threshold;
means for obtaining of an A-Threshold;
means for categorizing of said entity or said entity-instance with a label as no-focus if said current critical parameter value is <said P-Threshold and said current assessment is <said A-Threshold;
means for categorizing of said entity or said entity-instance with a label as balanced if said current critical parameter value is <said P-Threshold and said current assessment is not <said A-Threshold;
means for categorizing of said entity or said entity-instance with a label as over-focused if said current critical parameter value is not <said P-Threshold and said current assessment is <said A-Threshold;
means for categorizing of said entity or said entity-instance with a label as focused if said current critical parameter value is not <said P-Threshold and said current assessment is not <said A-Threshold;
means for determining of a plurality of entity-instances of said entity;
means for categorizing of each of said plurality of entity-instances into one of no-focus quadrant, balanced quadrant, over-focused quadrant, and focused quadrant;
means for computing of a plurality of denseness factors associated with no-focus quadrant, balanced quadrant, over-focused quadrant, and focused quadrant;
means for labeling of said entity with an abstract label based on said plurality of denseness factors; and
means for displaying of said label and said abstract label for providing said two-dimensional assessment—parametric visualization.
(BASED ON FIG. 9)

8. The system as claimed in claim 1, wherein said means for providing of visualization of said university model graph of said university based on said three relationship dimensions further comprises:
means for a pair level visualization;
means for a multiple level visualization; and
means for a rel-based visualization.
(BASED ON FIG. 3)

9. The system as claimed in claim 8, wherein said means for said pair level visualization further comprises:
means for obtaining of a pair of entity-instances, wherein an entity-instance 1 of said plurality of entity-instances is a part of said pair of entity-instances and an entity-instance 2 of said plurality of entity-instances is a part of said pair of entity-instances;
means for determining if said entity-instance 1 and said entity-instance 2 are neighbors in both directions;
means for computing of a current influence 12 based on said entity-instance 1, said entity-instance 2, and said university model graph database;
means for computing of a current influence 21 based on said entity-instance 1, said entity-instance 2, and said university model graph database;
means for displaying of said pair of entity-instances based on said current influence 12 and said current influence 21;
means for labeling of said pair of entity-instances with a label as null if said current influence 12 is close to 0 and said current influence 21 is close to 0;
means for labeling of said pair of entity-instances with a label as partially null if said current influence 12 is close to 0 or said current influence 21 is close to 0;
means for labeling of said pair of entity-instances with a label as considerate if said current influence 12 is not close to 0, said current influence 21 is not close to 0, and one of said current influence 12 or said current influence 21 is negative;
means for labeling of said pair of entity-instances with a label as destructive if said current influence 12 is not close to 0, said current influence 21 is not close to 0, and both said current influence 12 and said current influence 21 are negative;
means for labeling of said pair of entity-instances with a label as constructive if said current influence 12 is not close to 0, said current influence 21 is not close to 0, and both said current influence 12 and said current influence 21 are positive; and
means for display of said label for providing said pair level visualization.
(BASED ON FIGS. 10 AND 10a)

10. The system as claimed in claim 9, wherein said means for said pair level visualization further comprises:
means for determining if said entity-instance 2 is a neighbor of said entity-instance 1;
means for computing of a current influence 12 based on said entity-instance 1, said entity-instance 2, and said university model graph database;
means for determining of a plurality of indirect paths from said entity-instance 2 to said entity-instance 1; and
means for computing of a current influence 21 based on an influence value associated with each edge of each path of said plurality of indirect paths.
(BASED ON FIGS. 10 and 10a)

11. The system as claimed in claim 9, wherein said means for said pair level visualization further comprises:
means for determining if said entity-instance 1 and said entity-instance 2 are not neighbors;
means for determining of a plurality of indirect 12 paths from said entity-instance 1 to said entity-instance 2; and
means for computing of a current influence 12 based on an influence value associated with each edge of each path of said plurality of indirect 12 paths;
means for determining of a plurality of indirect 21 paths from said entity-instance 2 to said entity-instance 1; and
means for computing of a current influence 21 based on an influence value associated with each edge of each path of said plurality of indirect 21 paths.
(BASED ON FIGS. 10 and 10a)

12. The system as claimed in claim 9, wherein said means for said pair level visualization further comprises:
means for determining if said entity-instance 1 and said entity-instance 2 are not neighbors;
means for determining of a plurality of indirect 12 paths from said entity-instance 1 to said entity-instance 2; and
means for computing of a current influence 12 based on an influence value associated with each edge of each path of said plurality of indirect 12 paths;
means for determining of a plurality of indirect 21 paths from said entity-instance 2 to said entity-instance 1; and
means for computing of a current influence 21 as 0 if said plurality of indirect 21 paths is null.
(BASED ON FIGS. 10 and 10a)

13. The system as claimed in claim 9, wherein said means for said pair level visualization further comprises:
means for determining if said entity-instance 1 and said entity-instance 2 are not neighbors;
means for determining of a plurality of indirect 12 paths from said entity-instance 1 to said entity-instance 2; and
means for computing of a current influence 12 as 0 if said plurality of indirect 12 paths is null;
means for determining of a plurality of indirect 21 paths from said entity-instance 2 to said entity-instance 1; and
means for computing of a current influence 21 as 0 if said plurality of indirect 21 paths is null.
(BASED ON FIGS. 10 and 10a)

14. The system as claimed in claim 8, wherein said means for said multiple level visualization further comprises:
means for obtaining of a plurality of multiple level entity-instances of said plurality of entity-instances;
means for determining of a sub-graph based on said plurality of multiple level entity-instances and said university model graph database;
means for determining of an entity-instance 1 of said plurality of multiple level entity-instances and an entity-instance 2 of said plurality of multiple level entity-instances, wherein said entity-instance 1 and said entity-instance 2 are non-neighbors in said sub-graph;
means for determining of a sub-path between said entity-instance 1 and said entity-instance 2, wherein said sub-path has two nodes, a sub entity-instance 1 and a sub entity-instance 2 such that said sub entity-instance 1 and said sub entity-instance 2 are connected by a plurality of sub-path nodes, wherein each of said plurality of sub-path nodes is not a part of said sub-graph;
means for determining of a plurality of indirect paths from said sub entity-instance 1 and said sub entity-instance 2;
means for computing of a derived influence value based on an influence value associated with each edge of each path of said plurality of indirect paths;
means for updating said sub-path based on said derived influence value;
means for determining of a plurality of sub-graph influence values, wherein each of said sub-graph influence values is associated with the influence value of an edge of said sub-graph;
means for determining of a multiple-i-value based on said plurality of sub-graph influence values; and
means for displaying of said multiple-i-value for providing said multiple level visualization.
(BASED ON FIG. 10b)

15. The system as claimed in claim 8, wherein said means for said rel-based visualization further comprises:
means for obtaining a relation;
means for determining of a plurality of rel entity-instances, wherein said plurality of rel entity-instances satisfy said relation;
means for computing a multiple-i-value based on plurality of rel entity-instances; and
means for display of said multiple-i-value for providing said rel-based visualization.
(BASED ON FIG. 10c)

16. The system as claimed in claim 1, wherein said means for providing of visualization of said university model graph of said university based on said three partition dimensions further comprises:
means for a syntactic partition visualization;
means for a semantic partition visualization; and
means for a denseness-based partition visualization.
(BASED ON FIG. 3)

17. The system as claimed in claim 16, wherein said means for said syntactic partition visualization further comprises:
means for obtaining of a node of said university model graph;
means for making of said node a part of a plurality of syntactic nodes;
means for obtaining of a plurality of neighboring nodes of said node based on said university model graph;
means for obtaining of a neighboring node of said plurality of neighboring nodes;
means for computing of a plurality of influence factors based on said neighboring node and said plurality of syntactic nodes;
means for determining of a max influencing factor based on said plurality of influence factors;
means for checking of if said max influencing factor is >a pre-defined syntactic threshold;
means for making of said neighboring node a part of said plurality of syntactic nodes;
means for making of said plurality of syntactic nodes a part of a syntactic partition of said university model graph;
means for computing of a multiple-i-value based on said plurality of syntactic nodes;
means for determining of a plurality of multiple-i-values based on said syntactic partition;
means for displaying of said plurality of multiple-i-values for providing said syntactic partition visualization.
(BASED ON FIG. 11)

18. The system as claimed in claim 16, wherein said means for said semantic partition visualization further comprises:
means for obtaining of a semantic structure;
means for determining of a plurality of semantic nodes based on said semantic structure and said university model graph;
means for making of said plurality of semantic nodes a part of a semantic partition of said university model graph;
means for computing of multiple-i-values based on said plurality of semantic nodes;
means for determining of a plurality of multiple-i-values based on said semantic partition; and
means for display of said plurality of multiple-i-values for providing said semantic partition visualization.
(BASED ON FIG. 11a)

19. The system as claimed in claim 16, wherein said means for said denseness-based partition visualization further comprises:
means for obtaining of a denseness threshold and inter-dense threshold;
means for obtaining of a node of said university model graph, wherein a denseness factor of said node is >said denseness threshold;
means for making of said node a part of a plurality of denseness-based nodes;
means for obtaining of a plurality of neighboring nodes of said node based on said university model graph;
means for obtaining of a neighboring node of said plurality of neighboring nodes;
means for computing of a denseness factor of said neighboring node;
means for making of said neighboring node a part of said plurality of denseness-based nodes if said denseness factor is >said denseness threshold;
means for making of said neighboring node a part of said plurality of denseness-based nodes if said neighboring node is within said inter-dense threshold of a node of said plurality of denseness-based nodes;
means for making of said plurality of denseness-based nodes a part of a denseness-based partition of said university model graph;
means for computing of a multiple-i-value based on said plurality of denseness-based nodes;
means for determining of a plurality of multiple-i-values based on said denseness-based partition;
means for displaying of said plurality of multiple-i-values for providing said denseness-based partition visualization.
(BASED ON FIG. 11b)

20. The system as claimed in claim 1, wherein said means for providing of visualization of said university model graph of said university based on said three threshold dimensions further comprises:
means for obtaining of an entity-instance of said plurality of entity-instances;
means for determining a plurality of neighbors of said entity-instance;
means for computing of a sum-i-value based on an influence value associated with said entity-instance and each of said plurality of neighbors;
means for determining of an assessment of said entity-instance based on said university model graph database;
means for computing of a bag-factor based on said assessment and said sum-i-value;
means for categorizing of said entity-instance with a label as good if said bag-factor is >a pre-defined g-threshold;
means for categorizing of said entity-instance with a label as bad if said bag-factor is <a pre-defined b-threshold;
means for categorizing of said entity-instance with a label as average if said bag-factor is not >said pre-defined g-threshold and not <said pre-defined b-threshold; and
means for displaying of said bag-factor and said label for providing said three threshold dimensions based visualization.
(BASED ON FIG. 12)

21. The system as claimed in claim 1, wherein said means for providing of visualization of said university model graph of said university based on said three tracker dimensions further comprises:
means for obtaining of an entity-instance of said plurality of entity-instances;
means for obtaining of a time period;
means for obtaining of a time unit of said time period;
means for computing of a bag-factor of said entity-instance based on said time-unit;
means for making of said bag-factor a part of a plurality of track factors; and
means for displaying of said plurality of track factors for providing said three tracker dimensions based visualization.
(BASED ON FIG. 13)

22. The system as claimed in claim 1, wherein said means for providing of visualization of said university model graph of said university based on said three performance dimensions further comprises:
means for obtaining of an entity-instance of said plurality of entity-instances;
means for obtaining of a time period;
means for obtaining of a time unit of said time period;
means for determining of an assessment of said entity-instance based on said time-unit;
means for making of said assessment a part of a plurality of assessments;
means for computing of an assessment characterization based on said plurality of assessments;
means for categorizing of said entity-instance with a label as star performer if said assessment characterization is >a pre-defined st-threshold;
means for categorizing of said entity-instance with a label as bronze performer if said assessment characterization is <a pre-defined br-threshold;
means for categorizing of said entity-instance with a label as gold performer if said assessment characterization is not >said pre-defined st-threshold and not <said pre-defined br-threshold; and
means for displaying of said assessment characterization and said label for providing said three performance dimensions based visualization.
(BASED ON FIG. 14)

23. The system as claimed in claim 1, wherein said means for providing of visualization of said university model graph of said university based on said three impact dimensions further comprises:
means for obtaining of an entity-instance of said plurality of entity-instances;
means for obtaining of a time period;
means for obtaining of a time unit of said time period;
means for determining of an influencing factor of said entity-instance based on said time-unit;
means for making of said influencing factor a part of a plurality of influencing factors;
means for determining of an influenced factor of said entity-instance based on said time-unit;
means for making of said influenced factor a part of a plurality of influenced factors;
means for computing of an overall influencing factor based on said plurality of influencing factors;
means for computing of an overall influenced factor based on said plurality of influenced factors;
means for computing of an smb-factor based on said overall influencing factor and said overall influenced factor;
means for categorizing of said entity-instance with a label as sun-kind if said smb-factor is >a pre-defined su-threshold;
means for categorizing of said entity-instance with a label as blackhole-kind if said smb-factor is <a pre-defined bl-threshold;
means for categorizing of said entity-instance with a label as moon-kind if said smb-factor is not >said pre-defined su-threshold and not <said pre-defined bl-threshold; and
means for displaying of said label, said overall influencing factor, said overall influenced factor, and said smb-factor for providing said three impact dimensions based visualization.
(BASED ON FIG. 15)

24. The system as claimed in claim 1, wherein said means for providing of visualization of said university model graph of said university based on said three chain dimensions further comprises:
means for computing of a plurality of chains based on said university model graph;
means for obtaining of a chain of said plurality of chains;
means for obtaining of an edge of said chain;
means for determining of an influence value of said edge;
means for incrementing of a count-s if said influence value is >a pre-defined st-factor;
means for incrementing of a count-w if said influence value is <a pre-defined we-factor;
means for determining of a length of said chain;
means for categorizing of said chain with a label as strong-chain and incrementing of a strong-chain count, if said count-s is >a pre-defined sw-threshold times said length;
means for categorizing of said chain with a label as weak-chain and incrementing of a weak-chain count, if said count-w is >a pre-defined sw-threshold times said length;
means for categorizing of said chain with a label as strong-weak-chain and incrementing of a strong-weak-chain count, if said count-s is not >said pre-defined sw-threshold times said length and said count-w is not >said pre-defined sw-threshold times said length; and
means for displaying said label, said strong-chain count, said weak-chain count, and said strong-weak-chain count for providing said there chain dimensions based visualization.
(BASED ON FIG. 16).
